(19) United States
(12) Patent Application Publication
(10) Pub. No.: US 2023/0161635 A1
(43) Pub. Date: May 25, 2023

(54) REINFORCEMENT-LEARNING-BASED DISTRIBUTED-APPLICATION CONTROLLER INCORPORATING TRANSFER LEARNING

(71) Applicant: VMware, Inc., Palo Alto, CA (US)

(72) Inventors: Marius VILCU, Arlington, MA (US); Dongni Wang, Palo Alto, CA (US); Asmitha Rathis, Palo Alto, CA (US); Greg Burk, Colorado Springs, CO (US)

(73) Assignee: VMware, Inc., Palo Alto, CA (US)

(21) Appl. No.: 17/532,876

(22) Filed: Nov. 22, 2021

(51) Int. Cl. G06F 9/50; G06K 9/62; G06N 3/04

(52) U.S. Cl. CPC G06F 9/5055; G06K 9/6262; G06N 3/0454

(57) ABSTRACT

The current document is directed to a reinforcement-learning-based application manager that controls the operation of one or more applications and that employs transfer learning to improve initialization and operation of the reinforcement-learning-based application manager and to improve operation of the one or more distributed computer systems that host the applications controlled by the reinforcement-learning-based application manager. Transfer learning, in the disclosed implementations, is achieved by logically decomposing machine-learning-based function approximators for reinforcement-learning functions into component-specific function approximators, storing pre-trained function approximators and pre-trained component-specific function approximators, and initializing function approximators for reinforcement-learning-based application managers using the stored pre-trained function approximators and pre-trained component-specific function approximators.

### TECHNICAL FIELD

The current document is directed to distributed computer systems and to distributed-computer-system management and, in particular, to a reinforcement-learning-based application manager that controls the operation of one or more applications and that employs transfer learning to improve initialization and operation of the reinforcement-learning-based application manager and to improve operation of the one or more distributed computer systems that host the applications controlled by the reinforcement-learning-based application manager.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems has, in turn, become increasingly complex, involving greater computational overheads and significant inefficiencies and deficiencies. In fact, many desired management-and-administration functionalities are becoming sufficiently complex to render traditional approaches to the design and implementation of automated management and administration systems impractical, from a time and cost standpoint, and even from a feasibility standpoint. Therefore, designers and developers of various types of automated management and control systems related to distributed computing systems are seeking alternative design-and-implementation methodologies, including machine-learning-based approaches. The application of machine-learning technologies to the management of complex computational environments is still in early stages, but promises to expand the practically achievable feature sets of automated administration-and-management systems, decrease development costs, and provide a basis for more effective optimization In addition, administration-and-management control systems developed for distributed computer systems can often be applied to administer and manage standalone computer systems and individual, networked computer systems.

### SUMMARY

The current document is directed to a reinforcement-learning-based application manager that controls the operation of one or more applications and that employs transfer learning to improve initialization and operation of the reinforcement-learning-based application manager and to improve operation of the one or more distributed computer systems that host the applications controlled by the reinforcement-learning-based application manager. Transfer learning, in the disclosed implementations, is achieved by logically decomposing machine-learning-based function approximators for reinforcement-learning functions into component-specific function approximators, storing pre-trained function approximators and pre-trained component-specific function approximators, and initializing function approximators for reinforcement-learning-based application managers using the stored pre-trained function approximators and pre-trained component-specific function approximators.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing. In the recently developed cloud-computing paradigm, computing cycles and data-storage facilities are provided to organizations and individuals by cloud-computing providers.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a virtual-data-center management server and physical servers of a physical data center above which a virtual-data-center interface is provided by the virtual-data-center management server.

FIG. 9 illustrates a cloud-director level of abstraction. In FIG. 9, three different physical data centers 902-904 are shown below planes representing the cloud-director layer of abstraction 906-908.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIGS. 11A-C illustrate an application manager.

FIG. 12 illustrates, at a high level of abstraction, a reinforcement-learning-based application manager controlling a computational environment, such as a cloud-computing facility.

FIG. 13 summarizes the reinforcement-learning-based approach to control.

FIGS. 14A-B illustrate states of the environment.

FIG. 15 illustrates the concept of belief.

FIGS. 16A-B illustrate a simple flow diagram for the universe comprising the manager and the environment in one approach to reinforcement learning.

FIG. 17 provides additional details about the operation of the manager, environment, and universe.

FIG. 18 provides a somewhat more detailed control-flow-like description of operation of the manager and environment than originally provided in FIG. 16A.

FIG. 19 provides a traditional control-flow diagram for operation of the manager and environment over multiple runs.

FIG. 20 illustrates one approach to using reinforcement learning to generate and operate an application manager.

FIG. 21 illustrates an alternative view of a control trajectory comprising a sequence of executed actions, each accompanied by a managed-environment state change.

FIG. 22 illustrates the potential sizes of the set of possible state/action pairs.

FIGS. 23A-B illustrate the need for state/action exploration by a reinforcement-learning-based controller.

FIG. 24 provides expressions illustrating various types of policies.

FIG. 25 illustrates one implementation of a reinforcement-learning-based application manager that employs state action-space exploration via the above-discussed ϵ-greedy policy.

FIG. 26 illustrates a multi-level distributed application.

FIGS. 27A-B illustrate a simple example of a reinforcement-learning-based distributed-application manager/controller.

FIGS. 28A-H illustrate operation of the RL agent discussed with reference to FIGS. 27A-B.

FIG. 29 illustrates fundamental components of a feed-forward neural network.

FIG. 30 illustrates a small, example feed-forward neural network.

FIG. 31 provides a concise pseudocode illustration of the implementation of a simple feed-forward neural network.

FIG. 32 illustrates back propagation of errors through a neural network during training.

FIGS. 33A-B show the details of the weight-adjustment calculations carried out during back propagation.

FIGS. 34A-G illustrate an alternative implementation of the RL agent that uses a neural-network function approximator for the action-value function Q(s,a) rather than the tabular representation used in the implementation discussed above with reference to FIGS. 28A-H.

FIGS. 35A-B illustrate function-approximator decomposition with respect to distributed-application components.

FIG. 36 illustrates an efficient method by which distributed-application-component-based decomposition can be incorporated within an RL agent, including the example RL agent discussed above with reference to FIGS. 34A-G.

FIG. 37 illustrates composition of a composite function approximator for a new distributed application using pre-trained component-specific function approximators extracted from RL agents controlling existing distributed applications.

FIGS. 38A-B illustrate one implementation of an application database that is used to store information about pre-trained component-specific function approximators and composite function approximators that can be used to initialize new composite function approximators for RL agents intended to control and manage new distributed applications.

FIGS. 39A-G illustrate implementation of an automated method and system for selecting pre-trained component-specific function approximators for incorporation into a composite function approximator, discussed above with reference to FIGS. 35B and 36, using the application database discussed above with reference to FIGS. 38A-B.

### DETAILED DESCRIPTION

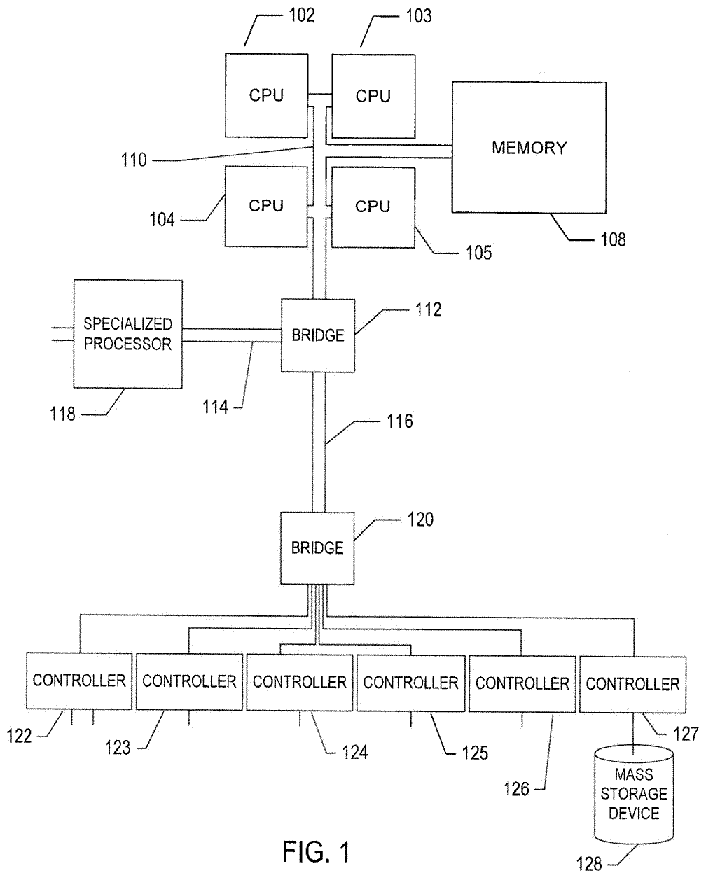

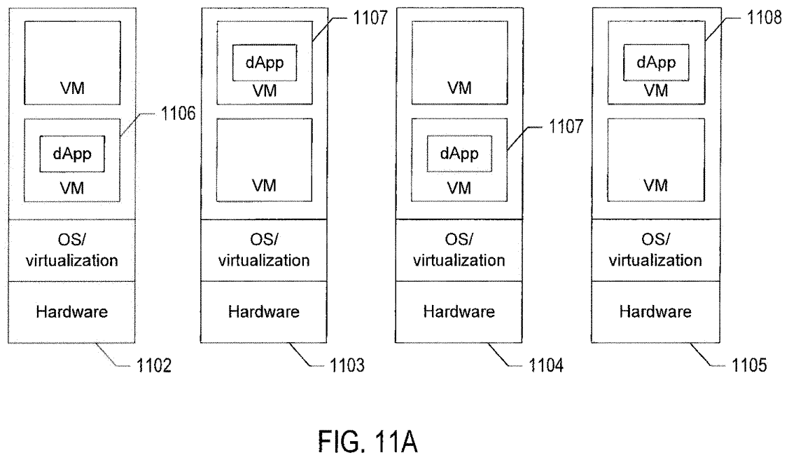

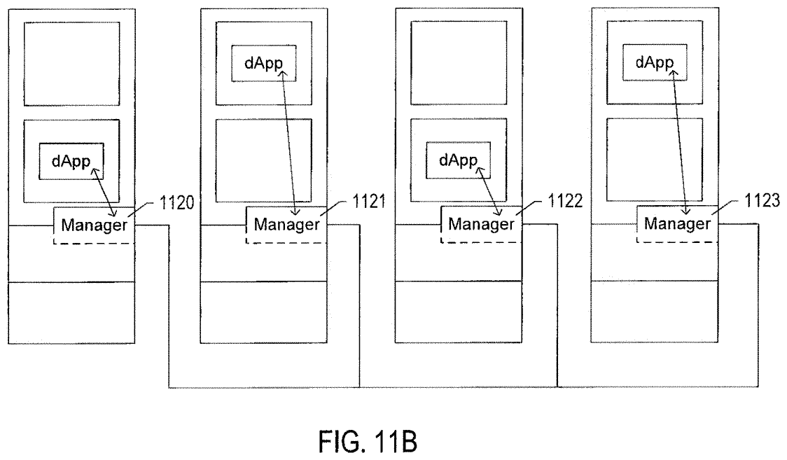

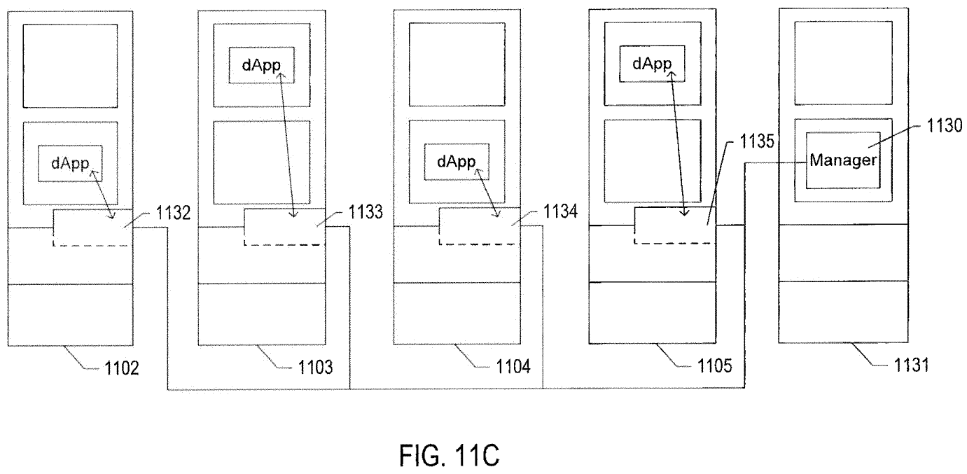

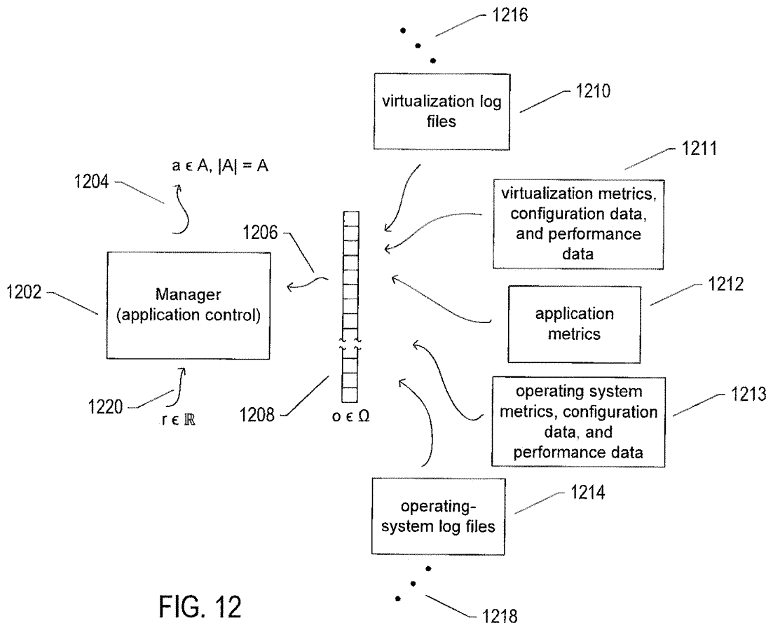

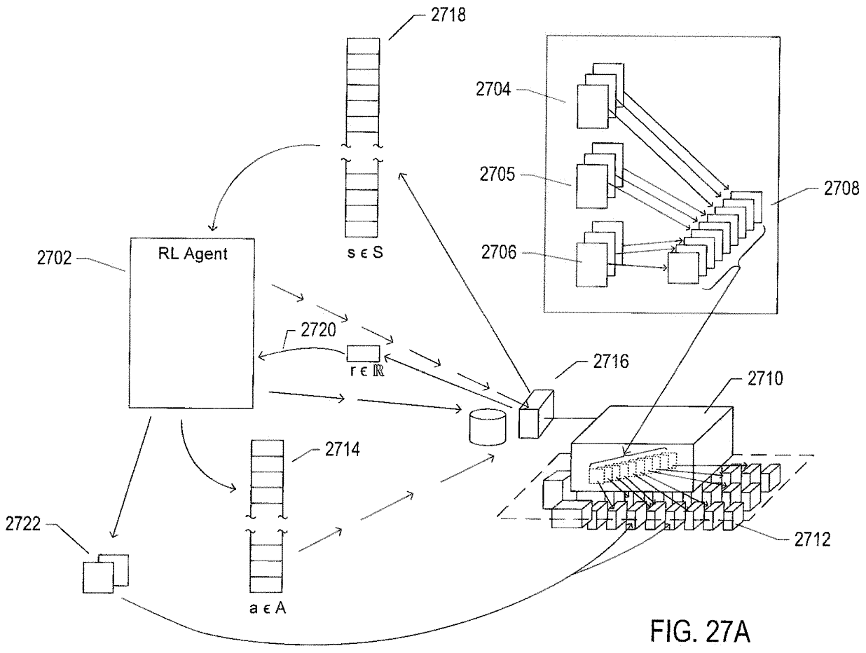

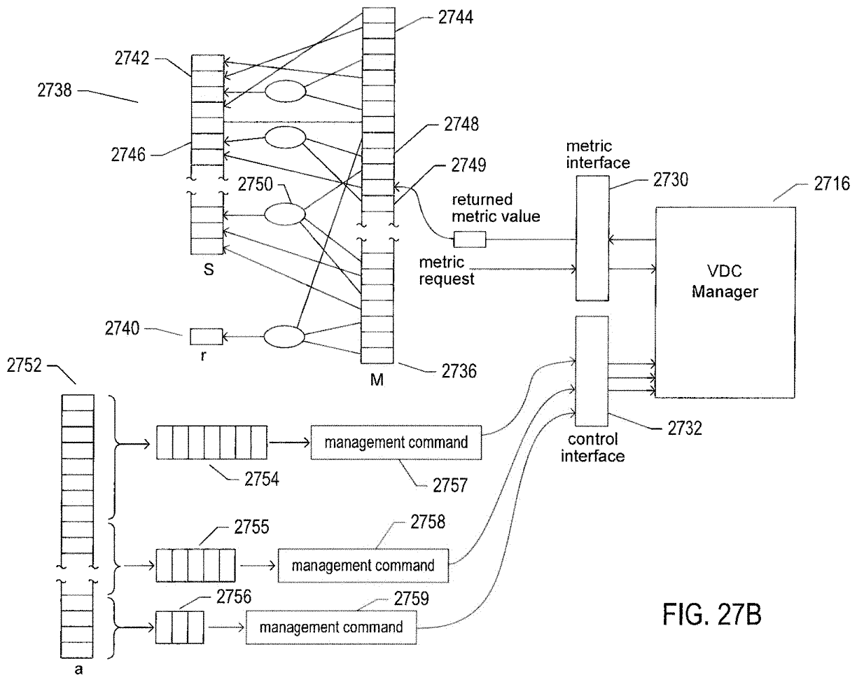

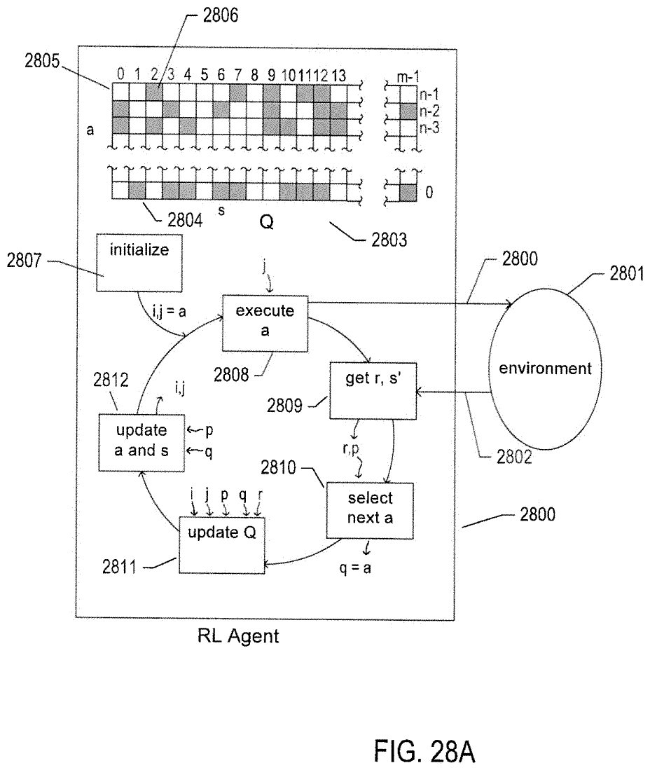

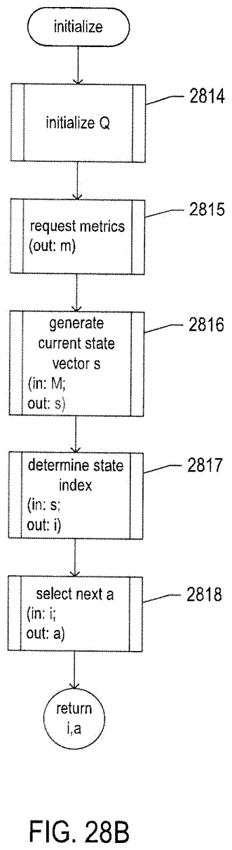

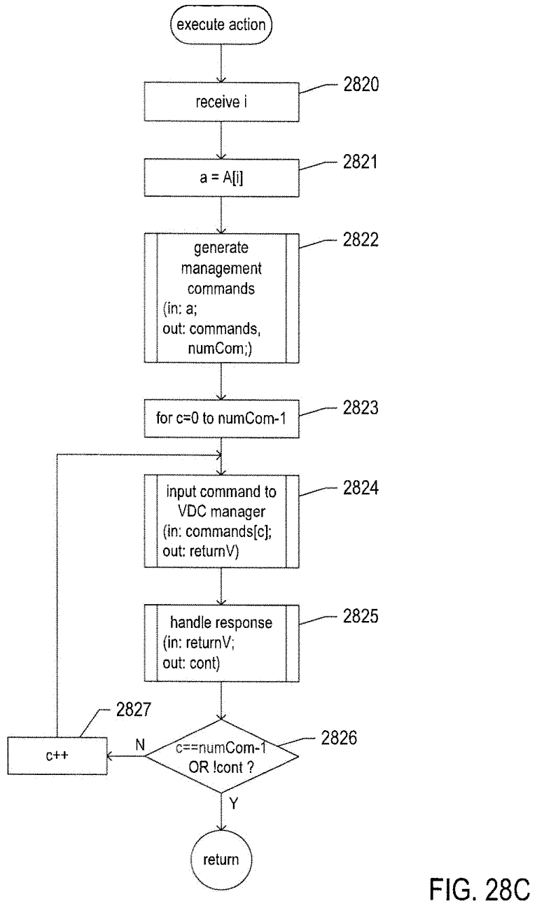

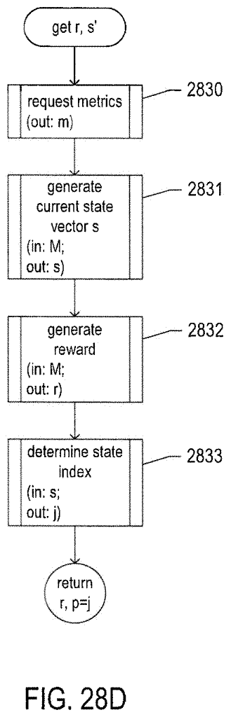

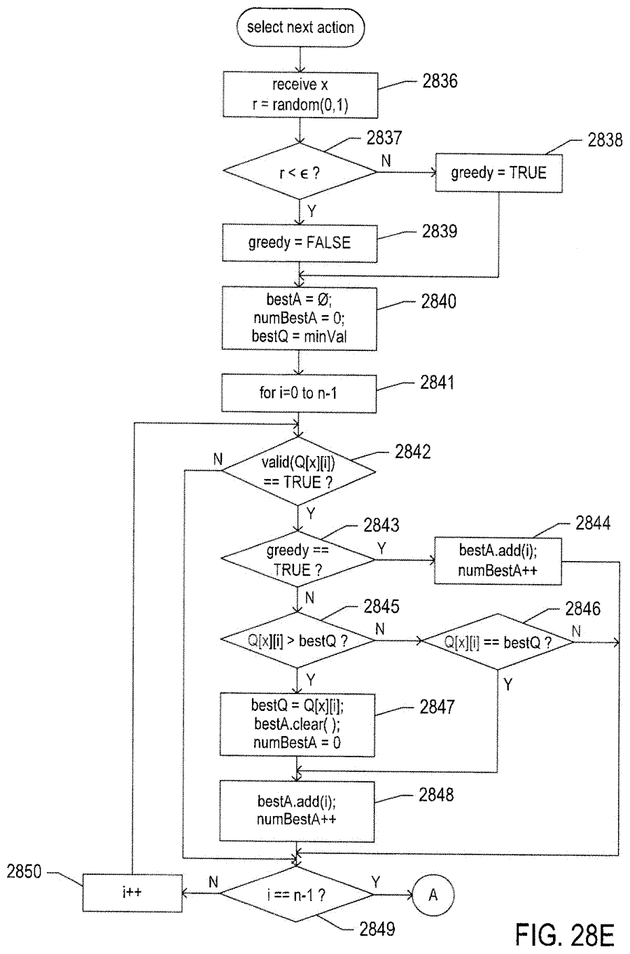

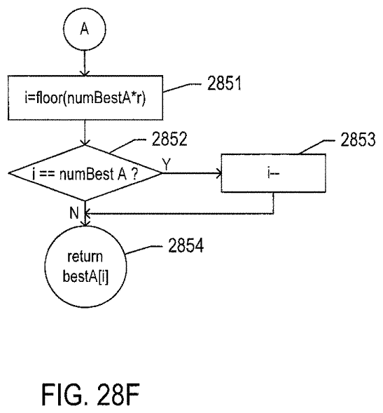

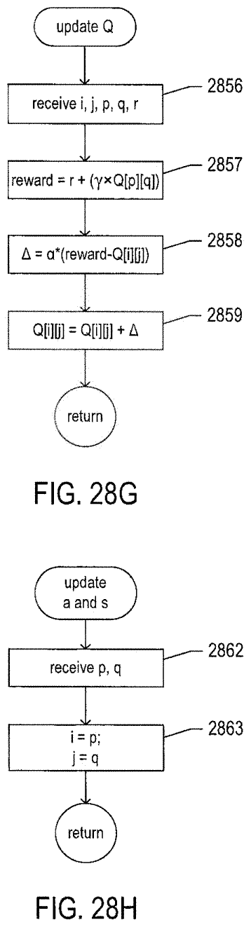

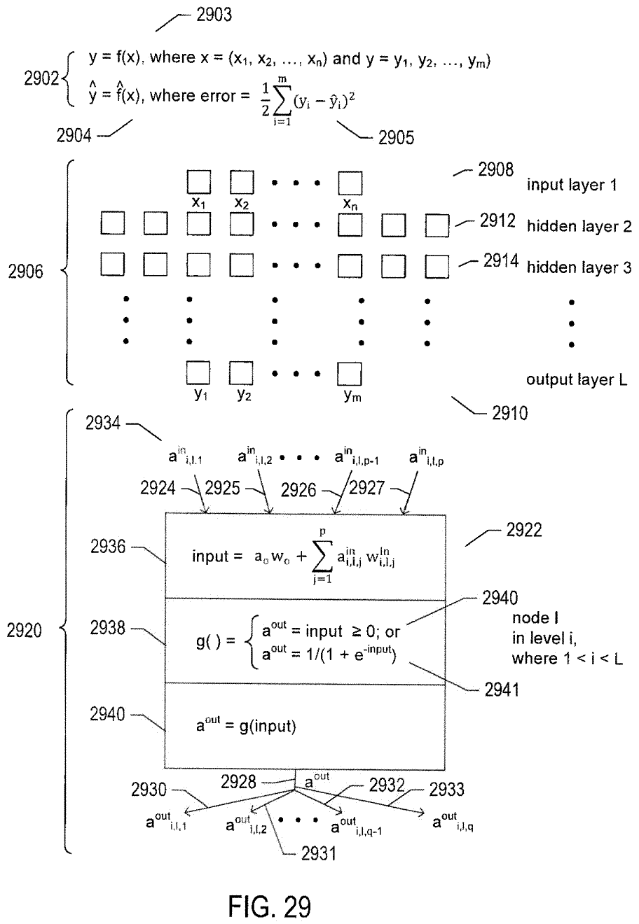

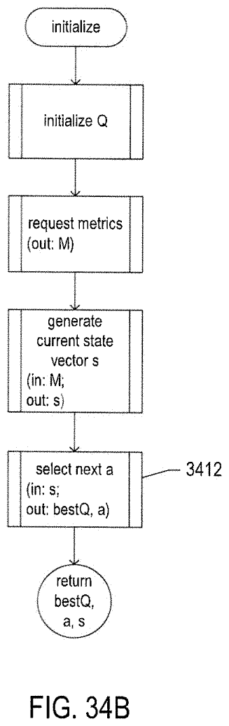

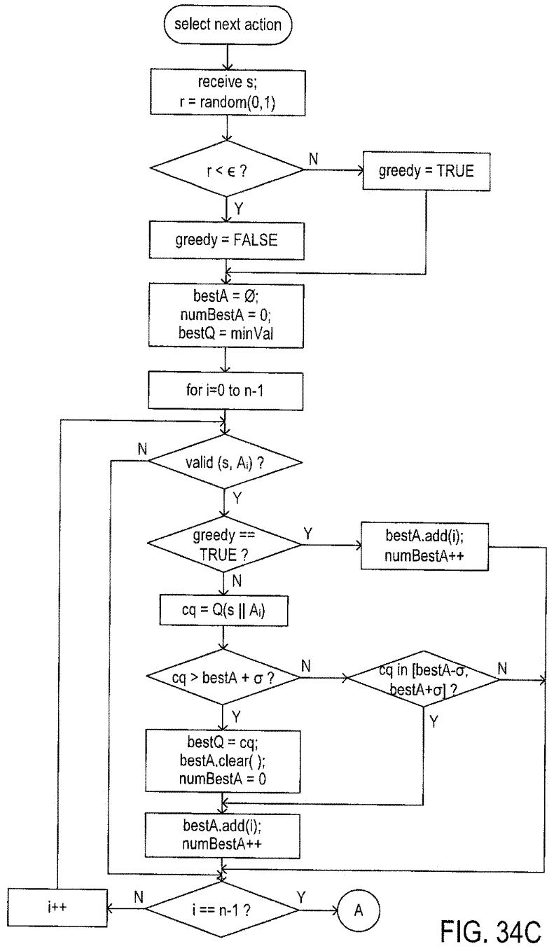

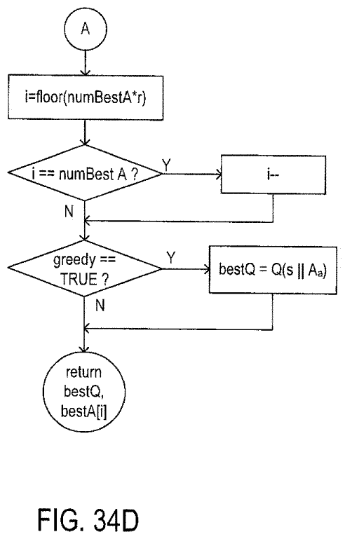

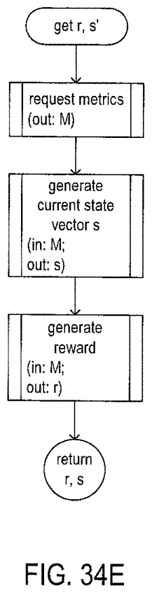

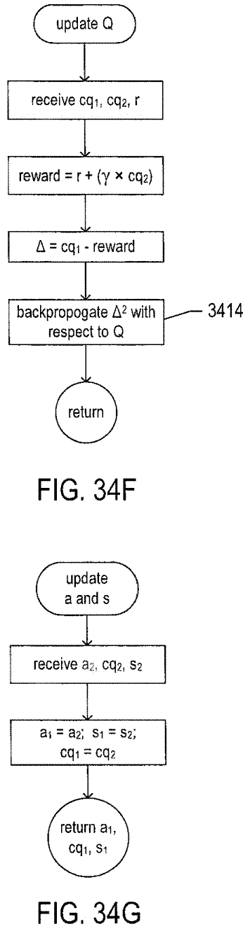

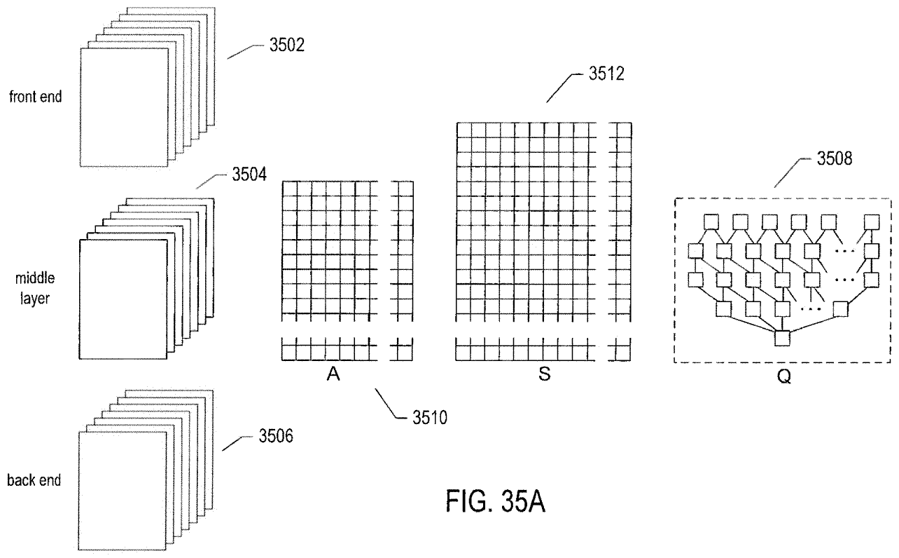

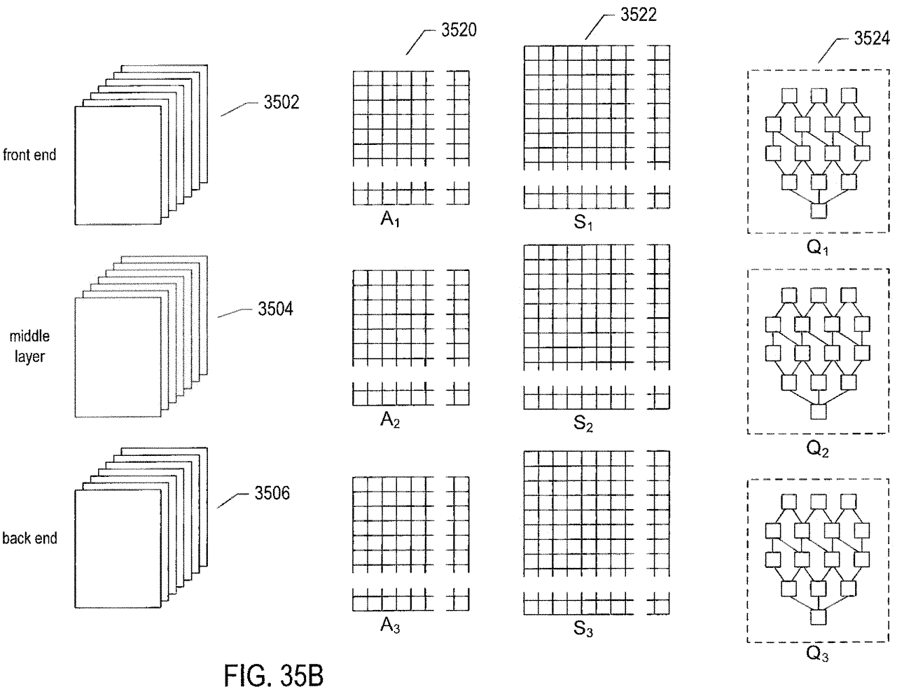

The current document is directed to a reinforcement-learning-based application manager that controls the operation of one or more applications and that employs transfer learning to improve initialization and operation of the reinforcement-learning-based application manager and to improve operation of the one or more distributed computer systems that host the applications controlled by the reinforcement-learning-based application manager. In a first subsection, below, a detailed description of computer hardware, complex computational systems, and virtualization is provided with reference to FIGS. 1-10. In a second subsection, application management and reinforcement learning are discussed with reference to FIGS. 11A-26. In a third subsection, a first implementation of an example RL agent used to describe the currently disclosed methods and systems is described with reference to FIGS. 27A-28H. In a fourth subsection, neural networks are described with reference to FIGS. 29-33B. In a fifth subsection, a second implementation of an example RL agent used to describe the currently disclosed methods and systems is described with reference to FIGS. 34A-G. In a sixth subsection, the currently disclosed methods and systems are discussed with reference to FIGS. 35A-39G.

### Computer Hardware, Complex Computational Systems, Virtualization, and Generation of Status Informational, and Error Data

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

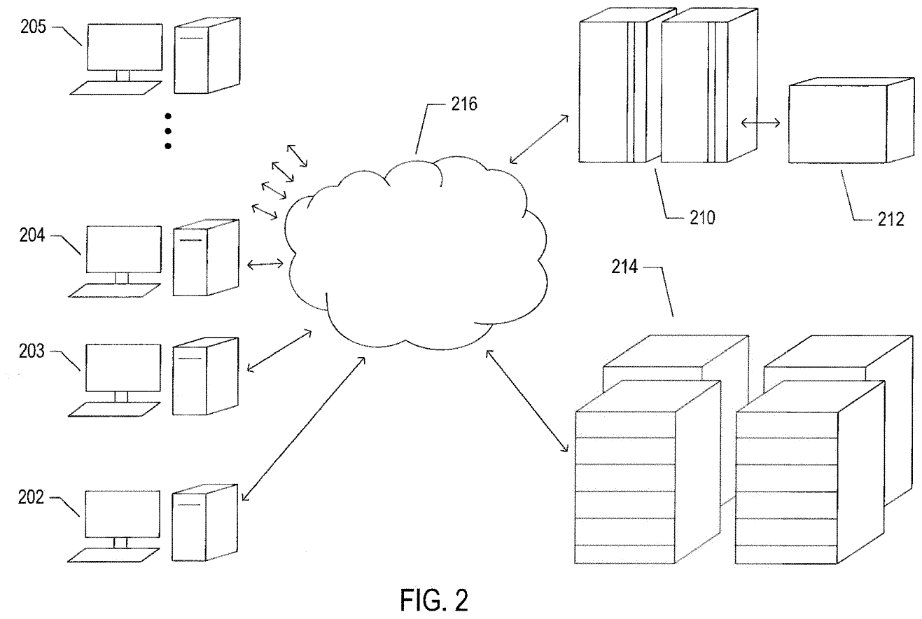

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

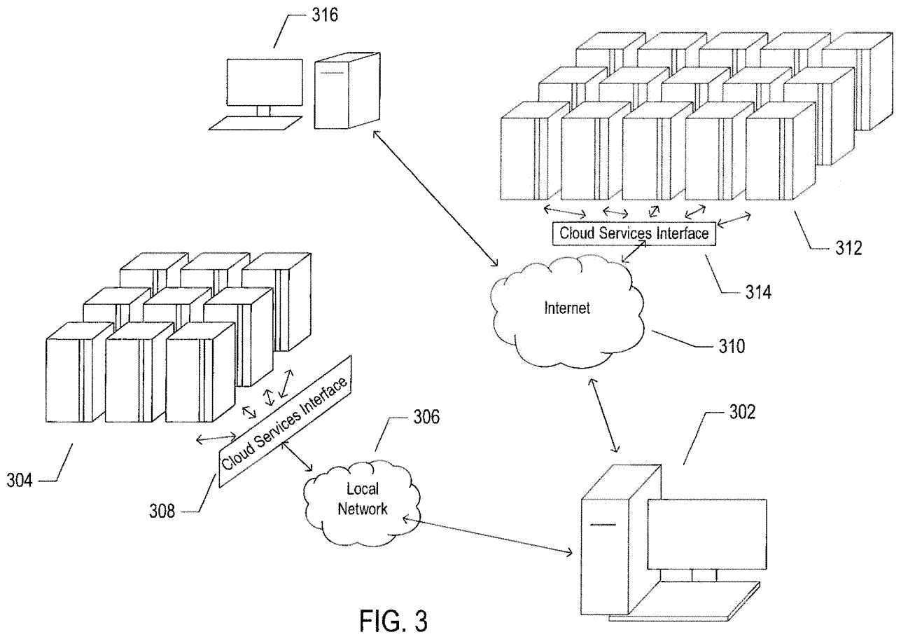

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

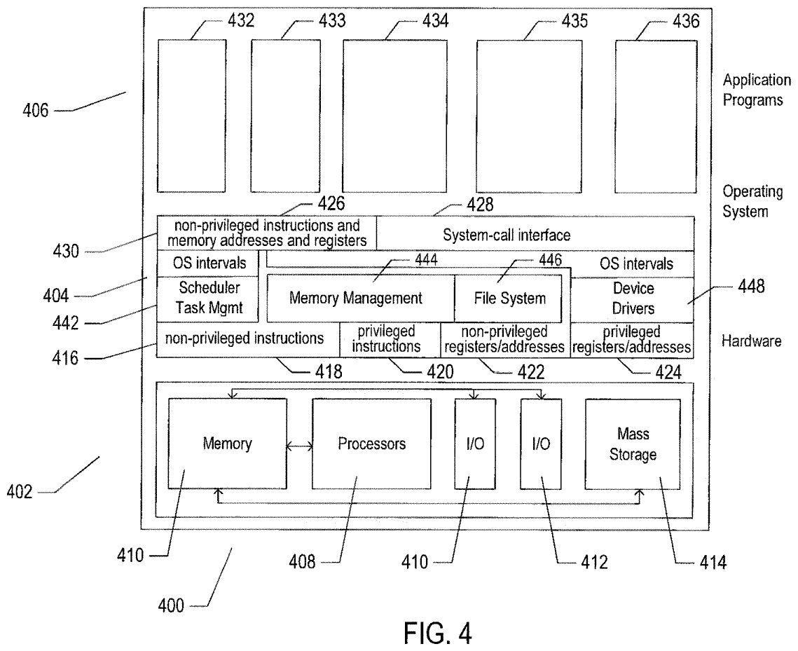

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

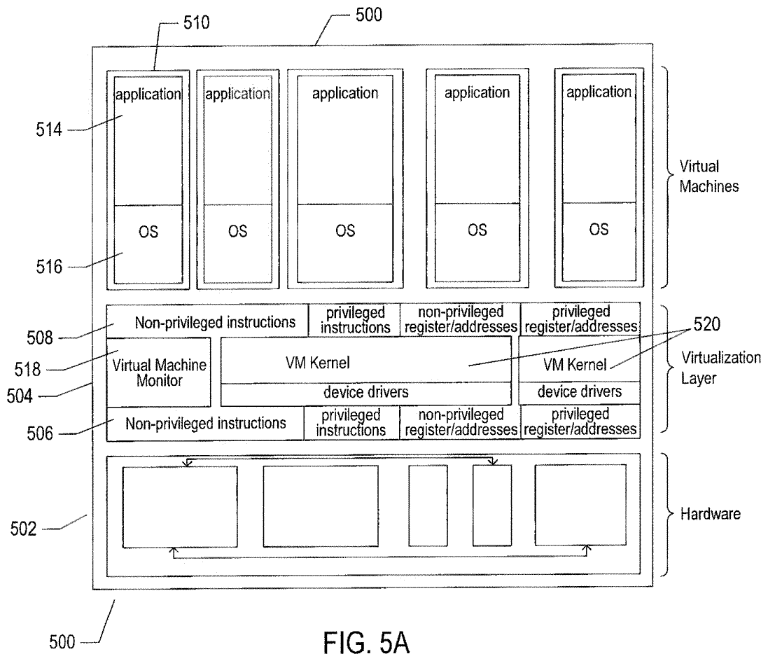

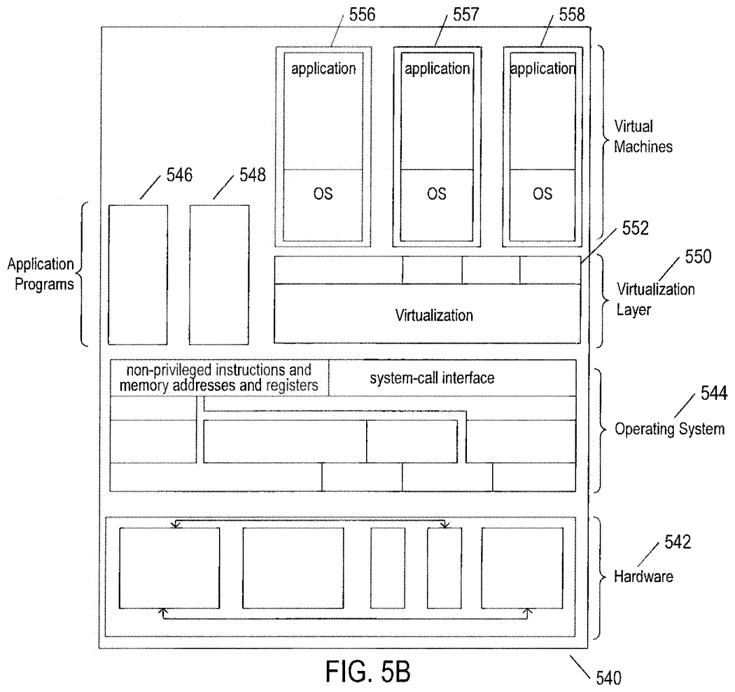

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

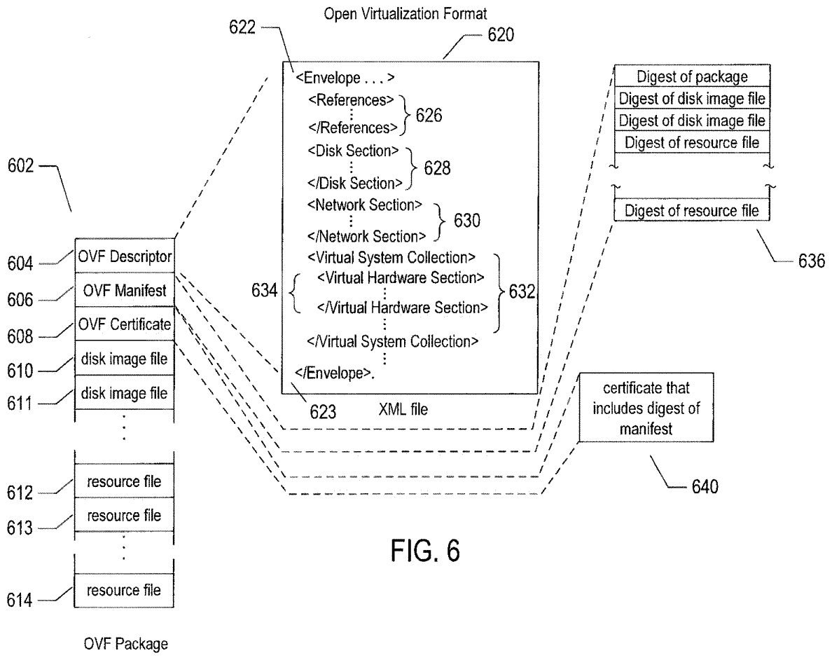

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

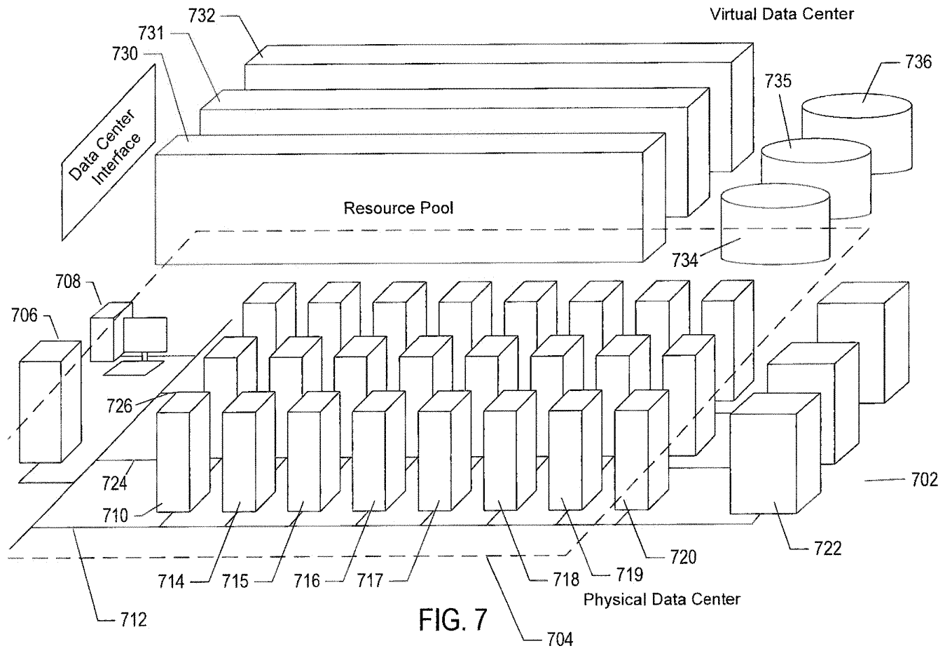

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers or virtual infrastructure, provides a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-data-center management server 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems, and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

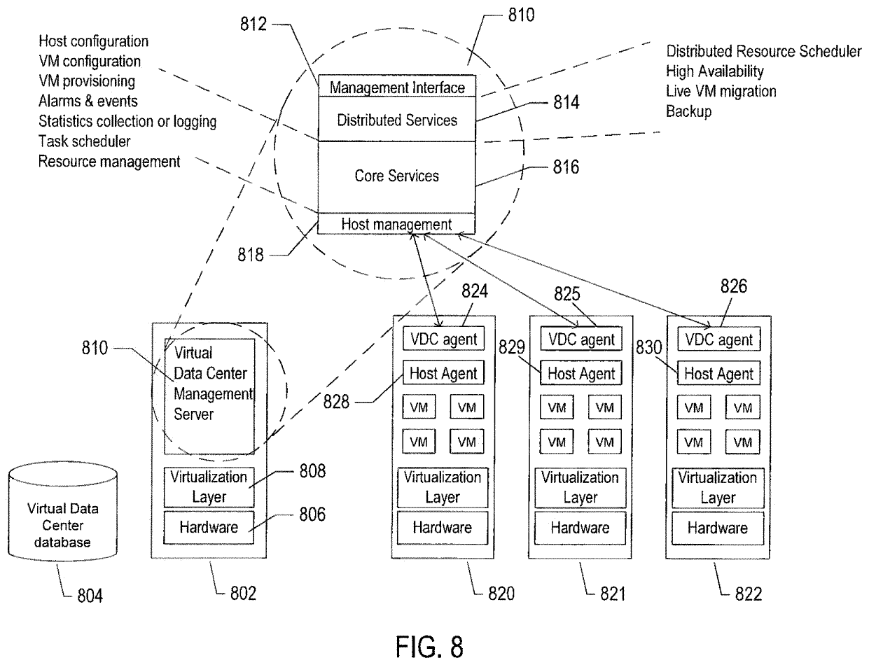

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the virtual-data-center management server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability. FIG. 8 illustrates virtual-machine components of a virtual-data-center management server and physical servers of a physical data center above which a virtual-data-center interface is provided by the virtual-data-center management server. The virtual-data-center management server 802 and a virtual-data-center database 804 comprise the physical components of the management component of the virtual data center. The virtual-data-center management server 802 includes a hardware layer 806 and virtualization layer 808, and runs a virtual-data-center management-server virtual machine 810 above the virtualization layer. Although shown as a single server in FIG. 8, the virtual-data-center management server (“VDC management server”) may include two or more physical server computers that support multiple VDC-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VDC management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VDC management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VDC management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

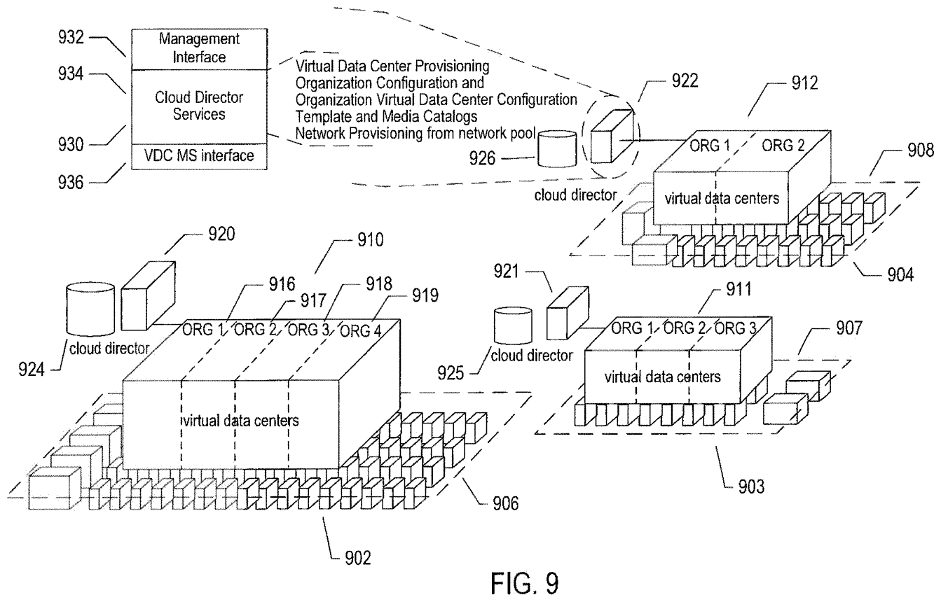

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

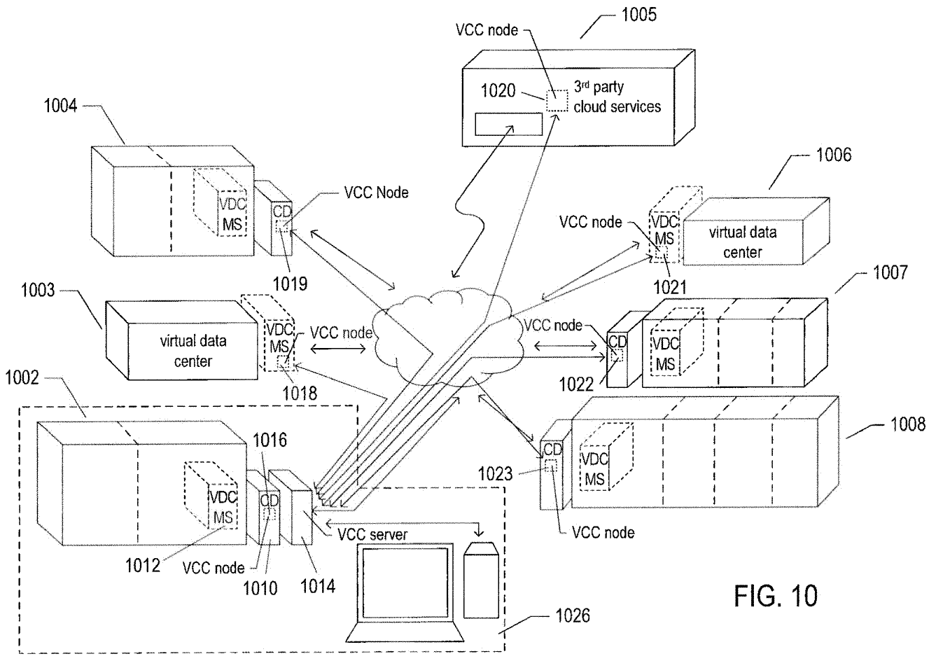

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Application Management and Reinforcement Learning

FIGS. 11A-C illustrate an application manager. All three figures use the same illustration conventions, next described with reference to FIG. 11A. The distributed computing system is represented, in FIG. 11A, by four servers 1102-1105 that each support execution of a virtual machine, 1106-1108 respectively, that provides an execution environment for a local instance of the distributed application. Of course, in real-life cloud-computing environments, a particular distributed application may run on many tens to hundreds of individual physical servers. Such distributed applications often require fairly continuous administration and management. For example, instances of the distributed application may need to be launched or terminated, depending on current computational loads, and may be frequently relocated to different physical servers and even to different cloud-computing facilities in order to take advantage of favorable pricing for virtual-machine execution, to obtain necessary computational throughput, and to minimize networking latencies. Initially, management of distributed applications as well as the management of multiple, different applications executing on behalf of a client or client organization of one or more cloud-computing facilities was carried out manually through various management interfaces provided by cloud-computing facilities and distributed-computer data centers. However, as the complexity of distributed-computing environments has increased and as the numbers and complexities of applications concurrently executed by clients and client organizations have increased, efforts have been undertaken to develop automated application managers for automatically monitoring and managing applications on behalf of clients and client organizations of cloud-computing facilities and distributed-computer-system-based data centers.

As shown in FIG. 11B, one approach to automated management of applications within distributed computer systems is to include, in each physical server on which one or more of the managed applications executes, a local instance of the distributed application manager 1120-1123. The local instances of the distributed application manager cooperate, in peer-to-peer fashion, to manage a set of one or more applications, including distributed applications, on behalf of a client or client organization of the data center or cloud-computing facility. Another approach, as shown in FIG. 11C, is to run a centralized or centralized-distributed application manager 1130 on one or more physical servers 1131 that communicates with application-manager agents 1132-1135 on the servers 1102-1105 to support control and management of the managed applications. In certain cases, application-management facilities may be incorporated within the various types of management servers that manage virtual data centers and aggregations of virtual data centers discussed in the previous subsection of the current document. The phrase “application manager” means, in this document, an automated controller that controls and manages applications programs and the computational environment in which they execute. Thus, an application manager may interface to one or more operating systems, virtualization layers, data-center managers, and virtual-data-center managers in addition to applications, in various implementations, to control and manage the applications and their computational environments. In certain implementations, an application manager may even control and manage virtual and/or physical components that support the computational environments in which applications execute.

In certain implementations, an application manager is configured to manage applications and their computational environments within one or more distributed computing systems based on a set of one or more policies, each of which may include various rules, parameter values, and other types of specifications of the desired operational characteristics of the applications. As one example, the one or more policies may specify threshold values for key-performance indicators, such as maximum average latencies for responding to user requests, maximum costs for executing virtual machines per hour or per day, the cost per transaction, and the number of transactions carried out per unit of time. Policy-driven approaches may be employed to optimize application operation. Such overall policies may be implemented by a combination of finer-grain policies, parameterized control programs, and other types of controllers that interface to operating-system and virtualization-layer-management subsystems. However, as the numbers and complexities of applications desired to be managed on behalf of clients and client organizations of data centers and cloud-computing facilities continues to increase, it is becoming increasingly difficult, if not practically impossible, to implement policy-driven application management by manual programming and/or policy construction. As a result, a new approach to application management based on the machine-learning technique referred to as “reinforcement learning” has been undertaken.

FIG. 12 illustrates, at a high level of abstraction, a reinforcement-learning-based application manager controlling a computational environment, such as a cloud-computing facility. The reinforcement-learning-based application manager 1202 manages one or more applications by emitting or issuing actions, as indicated by arrow 1204. These actions are selected from a set of actions A of cardinality |A|. Each action a in the set of actions A can be generally thought of as a vector of numeric values that specifies an operation that the manager is directing the environment to carry out. The environment may, in many cases, translate the action into one or more environment-specific operations that can be carried out by the computational environment controlled by the reinforcement-learning-based application manager. It should be noted that the cardinality |A| may be indeterminable, since the numeric values may include real values, and the action space may be therefore effectively continuous or effectively continuous in certain dimensions. The operations represented by actions may be, for example, commands, including command arguments, executed by operating systems, distributed operating systems, virtualization layers, management servers, and other types of control components and subsystems within one or more distributed computing systems or cloud-computing facilities. The reinforcement-learning-based application manager receives observations from the computational environment, as indicated by arrow 1206. Each observation o can be thought of as a vector of numeric values 1208 selected from a set of possible observation vectors Ω. The set Ω may, of course, be quite large and even practically innumerable. Each element of the observation o represents, in certain implementations, a particular type of metric or observed operational characteristic or parameter, numerically encoded, that is related to the computational environment. The metrics may have discrete values or real values, in various implementations. For example, the metrics or observed operational characteristics may indicate the amount of memory allocated for applications and/or application instances, networking latencies experienced by one or more applications, an indication of the number of instruction-execution cycles carried out on behalf of applications or local-application instances, and many other types of metrics and operational characteristics of the managed applications and the computational environment in which the managed applications run. As shown in FIG. 12, there are many different sources 1210-1214 for the values included in an observation o, including virtualization-layer and operating-system log files 1210 and 1214, virtualization-layer metrics, configuration data, and performance data provided through a virtualization-layer management interface 1211, various types of metrics generated by the managed applications 1212, and operating-system metrics, configuration data, and performance data 1213. Ellipses 1216 and 1218 indicate that there may be many additional sources for observation values. In addition to receiving observation vectors o, the reinforcement-learning-based application manager receives rewards, as indicated by arrow 1220. Each reward is a numeric value that represents the feedback provided by the computational environment to the reinforcement-learning-based application manager after carrying out the most recent action issued by the manager and transitioning to a resultant state, as further discussed below. The reinforcement-learning-based application manager is generally initialized with an initial policy that specifies the actions to be issued in response to received observations and over time, as the application manager interacts with the environment, the application manager adjusts the internally maintained policy according to the rewards received following issuance of each action. In many cases, after a reasonable period of time, a reinforcement-learning-based application manager is able to learn a near-optimal or optimal policy for the environment, such as a set of distributed applications, that it manages. In addition, in the case that the managed environment evolves over time, a reinforcement-learning-based application manager is able to continue to adjust the internally maintained policy in order to track evolution of the managed environment so that, at any given point in time, the internally maintained policy is near-optimal or optimal. In the case of an application manager, the computational environment in which the applications run may evolve through changes to the configuration and components, changes in the computational load experienced by the applications and computational environment, and as a result of many additional changes and forces. The received observations provide the information regarding the managed environment that allows the reinforcement-learning-based application manager to infer the current state of the environment which, in turn, allows the reinforcement-learning-based application manager to issue actions that push the managed environment towards states that, over time, produce the greatest reward feedbacks. Of course, similar reinforcement-learning-based application managers may be employed within standalone computer systems, individual, networked computer systems, various processor-controlled devices, including smart phones, and other devices and systems that run applications.

Certain types of reinforcement-learning-based application managers control and manage multiple different applications according to a single policy. Other types of reinforcement-learning-based application managers control and manage multiple different applications according to multiple policies. In some cases, each application is associated with an application-specific policy while, in other cases, groups of one or more applications are associated with group-specific policies. In certain implementations, each distributed application is managed by a single reinforcement-learning-based application manager associated with the distributed application.

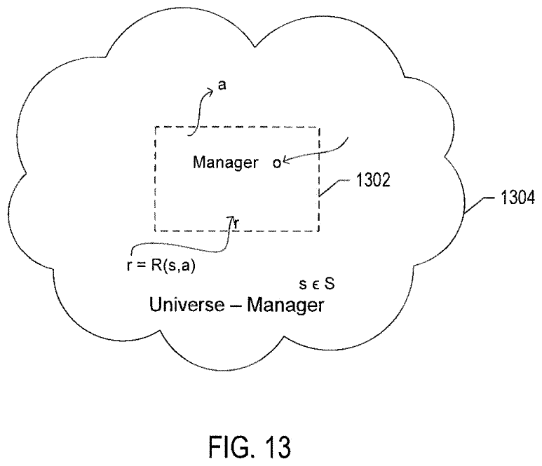

FIG. 13 summarizes the reinforcement-learning-based approach to control. The manager or controller 1302, referred to as a “reinforcement-learning agent,” is contained within, but is distinct and separate from, the universe 1304. Thus, the universe comprises the manager or controller 1302 and the portion of the universe not included in the manager, in set notation referred to as “universe-manager.” In the current document, the portion of the universe not included in the manager is referred to as the “environment.” In the case of an application manager, the environment includes the managed applications, the physical computational facilities in which they execute, and even generally includes the physical computational facilities in which the manager executes. The rewards are generated by the environment and the reward-generation mechanism cannot be controlled or modified by the manager.

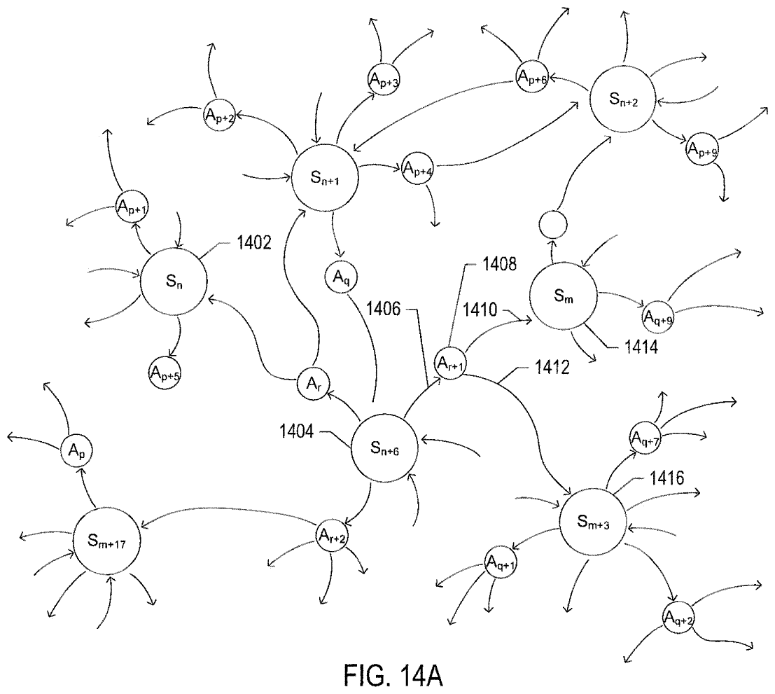

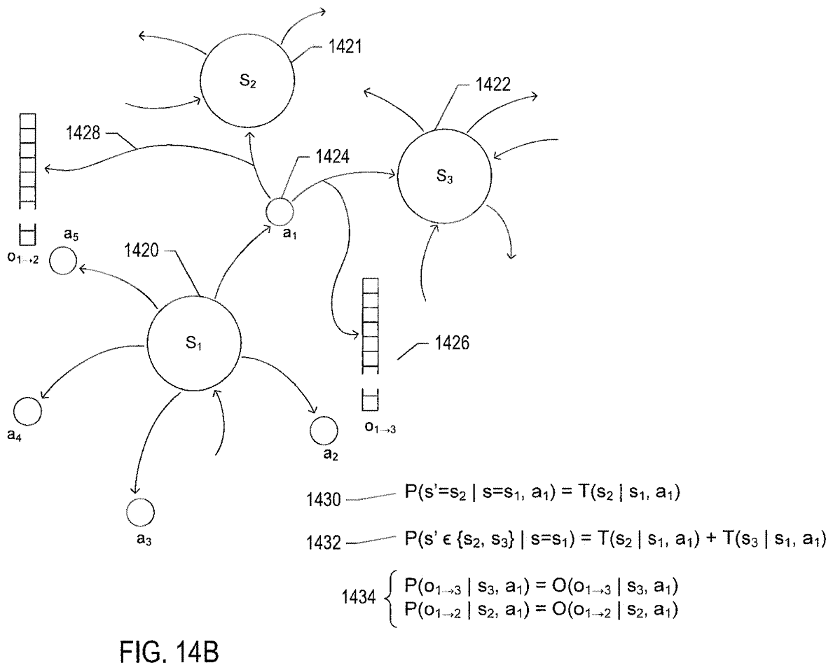

FIGS. 14A-B illustrate states of the environment. In the reinforcement-learning approach, the environment is considered to inhabit a particular state at each point in time. The state may be represented by one or more numeric values or character-string values, but generally is a function of hundreds, thousands, millions, or more different variables. The observations generated by the environment and transmitted to the manager reflect the state of the environment at the time that the observations are made. The possible state transitions can be described by a state-transition diagram for the environment. FIG. 14A illustrates a portion of a state-transition diagram. Each of the states in the portion of the state-transition diagram shown in FIG. 14A are represented by large, labeled disks, such as disc 1402 representing a particular state Sₙ. The transition between one state to another state occurs as a result of an action, emitted by the manager, that is carried out within the environment. Thus, arrows incoming to a given state represent transitions from other states to the given state and arrows outgoing from the given state represent transitions from the given state to other states. For example, one transition from state 1404, labeled Sₙ₊₆ is represented by outgoing arrow 1406. The head of this arrow points to a smaller disc that represents a particular action 1408. This action node is labeled Aᵣ₊₁. The labels for the states and actions may have many different forms, in different types of illustrations, but are essentially unique identifiers for the corresponding states and actions. The fact that outgoing arrow 1406 terminates in action 1408 indicates that transition 1406 occurs upon carrying out action 1408 within the environment when the environment is in state 1404. Outgoing arrows 1410 and 1412 emitted by action node 1408 terminate at states 1414 and 1416, respectively. These arrows indicate that carrying out action 1408 by the environment when the environment is in state 1404 results in a transition either to state 1414 or to state 1416. It should also be noted that an arrow emitted from an action node may return to the state from which the outgoing arrow to the action node was emitted. In other words, carrying out certain actions by the environment when the environment is in a particular state may result in the environment maintaining that state. Starting at an initial state, the state-transition diagram indicates all possible sequences of state transitions that may occur within the environment. Each possible sequence of state transitions is referred to as a “trajectory.”

FIG. 14B illustrates additional details about state-transition diagrams and environmental states and behaviors. FIG. 14B shows a small portion of a state-transition diagram that includes three state nodes 1420-1422. A first additional detail is the fact that, once an action is carried out, the transition from the action node to a resultant state is accompanied by the emission of an observation, by the environment, to the manager. For example, a transition from state 1420 to state 1422 as a result of action 1424 produces observation 1426, while transition from state 1420 to state 1421 via action 1424 produces observation 1428. A second additional detail is that each state transition is associated with a probability. Expression 1430 indicates that the probability of transitioning from state s₁ to state s₂ as a result of the environment carrying out action a₁, where s indicates the current state of the environment and s′ indicates the next state of the environment following s, is output by the state-transition function T, which takes, as arguments, indications of the initial state, the final state, and the action. Thus, each transition from a first state through a particular action node to a second state is associated with a probability. The second expression 1432 indicates that probabilities are additive, so that the probability of a transition from state s₁ to either state s₂ or state s₃ as a result of the environment carrying out action a₁ is equal to the sum of the probability of a transition from state s₁ to state s₂ via action a₁ and the probability of a transition from state s₁ to state s₃ via action a₁. Of course, the sum of the probabilities associated with all of the outgoing arrows emanating from a particular state is equal to 1.0, for all non-terminal states, since, upon receiving an observation/reward pair following emission of a first action, the manager emits a next action unless the manager terminates. As indicated by expressions 1434, the function O returns the probability that a particular observation o is returned by the environment given a particular action and the state to which the environment transitions following execution of the action. In other words, in general, there are many possible observations o that might be generated by the environment following transition to a particular state through a particular action, and each possible observation is associated with a probability of occurrence of the observation given a particular state transition through a particular action.

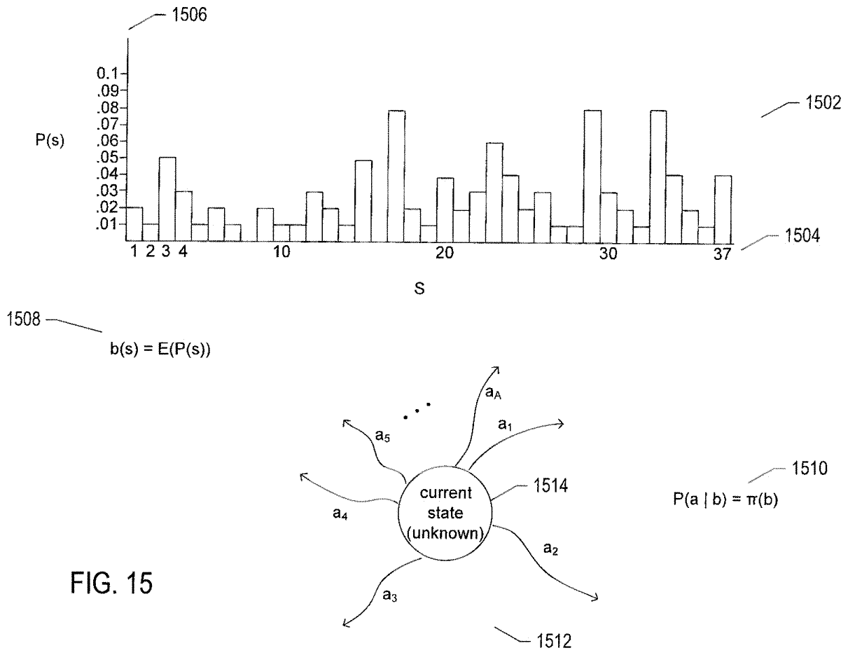

FIG. 15 illustrates the concept of belief. At the top of FIG. 15, a histogram 1502 is shown. The horizontal axis 1502 represents 37 different possible states for a particular environment and the vertical axis 1506 represents the probability of the environment being in the corresponding state at some point in time. Because the environment must be in one state at any given point in time, the sum of the probabilities for all the states is equal to 1.0. Because the manager does not know the state of the environment, but instead only knows the values of the elements of the observation following the last executed action, the manager infers the probabilities of the environment being in each of the different possible states. The manager's belief b(s) is the expectation of the probability that the environment is in state s, as expressed by equation 1508. Thus, the belief h is a probability distribution which could be represented in a histogram similar to histogram 1502. Over time, the manager accumulates information regarding the current state of the environment and the probabilities of state transitions as a function of the belief distribution and most recent actions, as a result of which the probability distribution b shifts towards an increasingly non-uniform distribution with greater probabilities for the actual state of the environment. In a deterministic and fully observable environment, in which the manager knows the current state of the environment, the policy π maintained by the manager can be thought of as a function that returns the next action a to be emitted by the manager to the environment based on the current state of the environment, or, in mathematical notation, a=π(s). However, in the non-deterministic and non-transparent environment in which application managers operate, the policy π maintained by the manager determines a probability for each action based on the current belief distribution b, as indicated by expression 1510 in FIG. 15, and an action with the highest probability is selected by the policy π, which can be summarized, in more compact notation, by expression 1511. Thus, as indicated by the diagram of a state 1512, at any point in time, the manager does not generally certainly know the current state of the environment, as indicated by the label 1514 within the node representation of the current date 1512, as a result of which there is some probability, for each possible state, that the environment is currently in that state. This, in turn, generally implies that there is a non-zero probability that each of the possible actions that the manager can issue should be the next issued action, although there are cases in which, although the state of the environment is not known with certain, there is enough information about the state of the environment to allow a best action to be selected.

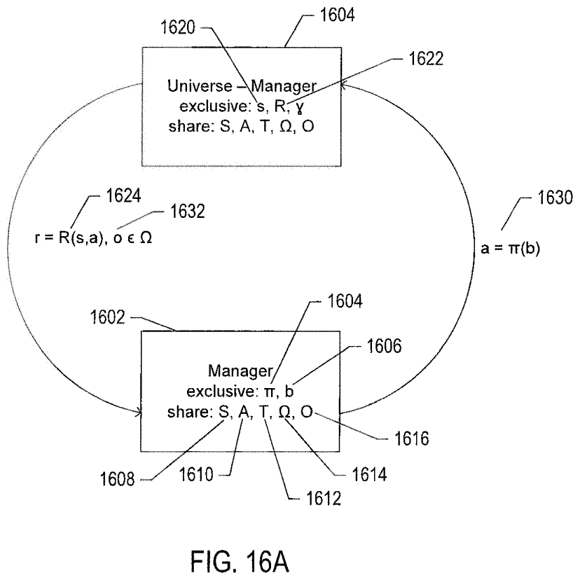

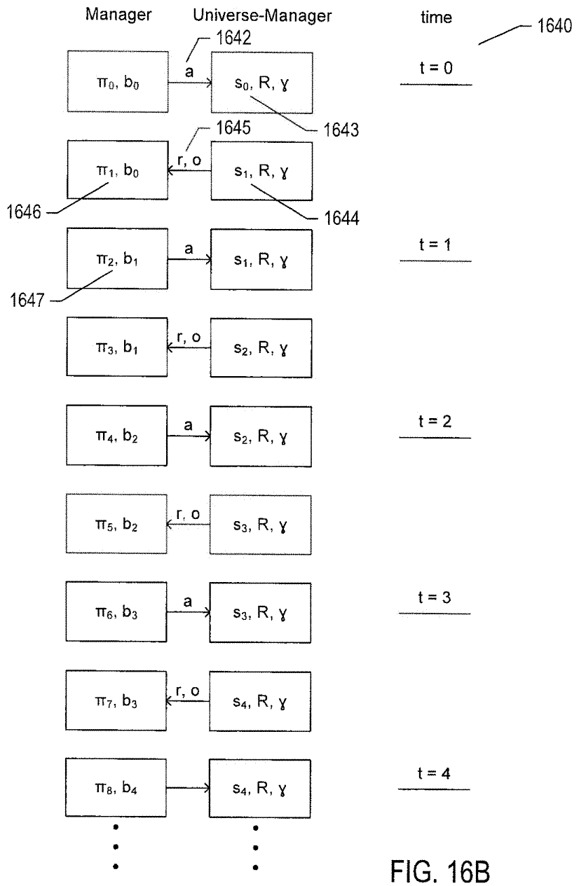

FIGS. 16A-B illustrate a simple flow diagram for the universe comprising the manager and the environment in one approach to reinforcement learning. The manager 1602 internally maintains a policy π 1604 and a belief distribution b 1606 and is aware of the set of environment states S 1608, the set of possible actions A 1610, the state-transition function T 1612, the set of possible observations Ω 1614 and, and the observation-probability function O 1616, all discussed above. The environment 1604 shares knowledge of the sets A, and Ω with the manager. Usually, the true state space S and the functions T and O are unknown and estimated by the manager. The environment maintains the current state of the environment s 1620, a reward function R 1622 that returns a reward r in response to an input current state s and an input action a received while in the current state 1624, and a discount parameter γ 1626, discussed below. The manager is initialized with an initial policy and belief distribution. The manager emits a next action 1630 based on the current belief distribution which the environment then carries out, resulting in the environment occupying a resultant state and then issues a reward 1624 and an observation o 1632 based on the resultant state and the received action. The manager receives the reward and observation, generally updates the internally stored policy and belief distribution, and then issues a next action, in response to which the environment transitions to a resultant state and emits a next reward and observation. This cycle continues indefinitely or until a termination condition arises.

It should be noted that this is just one model of a variety of different specific models that may be used for a reinforcement-learning agent and environment. There are many different models depending on various assumptions and desired control characteristics.

FIG. 16B shows an alternative way to illustrate operation of the universe. In this alternative illustration method, a sequence of time steps is shown, with the times indicated in a right-hand column 1640. Each time step consists of issuing, by the manager, an action to the environment and issuing, by the environment, a reward and observation to the manager. For example, in the first time step t=0, the manager issues an action a 1642, the environment transitions from state s₀ 1643 to s₁ 1644, and the environment issues a reward r and observation o 1645 to the manager. As a result, the manager updates the policy and belief distribution in preparation for the next time step. For example, the initial policy and belief distribution π₀ and b₀ 1646 are updated to the policy and belief distribution π₁ and b₁ 1647 at the beginning of the next time step t=1. The sequence of states {s₀, s₁, . . . } represents the trajectory of the environment as controlled by the manager. Each time step is thus equivalent to one full cycle of the control-flow-diagram-like representation discussed above with reference to FIG. 16A.

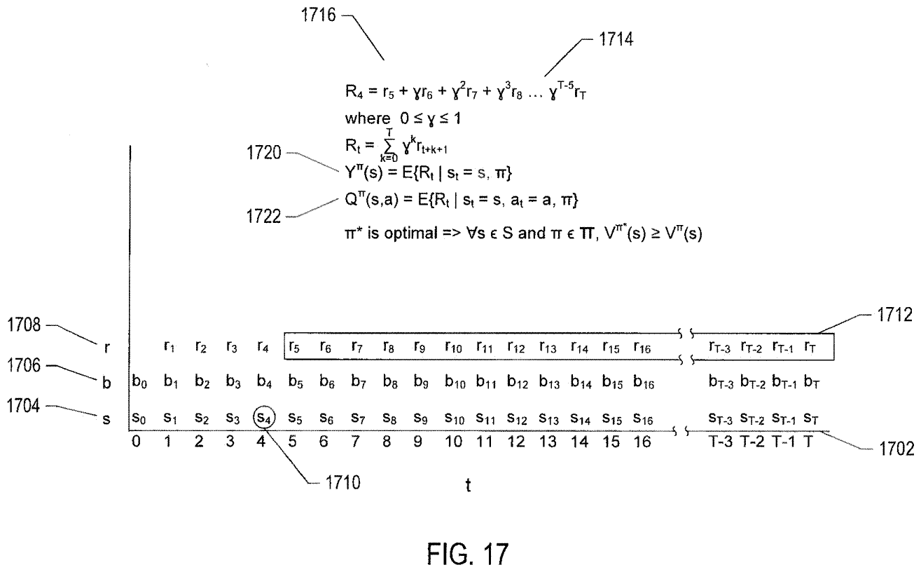

FIG. 17 provides additional details about the operation of the manager, environment, and universe. At the bottom of FIG. 17, a trajectory for the manager and environment is laid out horizontally with respect to the horizontal axis 1702 representing the time steps discussed above with reference to FIG. 16B. A first horizontal row 1704 includes the environment states, a second horizontal row 1706 includes the belief distributions, and a third horizontal row 1708 includes the issued rewards. At any particular state, such as circled state s₄ 1710, one can consider all of the subsequent rewards, shown for state s₄ within box 1712 in FIG. 17. The discounted return for state s₄, G₄, is the sum of a series of discounted rewards 1714. The first term in the series 1716 is the reward r₅ returned when the environment transitions from state s₄ to state s₅. Each subsequent term in the series includes the next reward multiplied by the discount rate γ raised to a power. The discounted reward can be alternatively expressed using a summation, as indicated in expression 1718. The value of a given state s, assuming a current policy π, is the expected discounted return for the state, and is returned by a value function V^{π}( ), as indicated by expression 1720. Alternatively, an action-value function returns a discounted return for a particular state and action, assuming a current policy, as indicated by expression 1722. An optimal policy π* provides a value for each state that is greater than or equal to the value provided by any possible policy π in the set of possible policies Π. There are many different ways for achieving an optimal policy. In general, these involve running a manager to control an environment while updating the value function V^{π}( ) and policy π, either in alternating sessions or concurrently. In some approaches to reinforcement learning, when the environment is more or less static, once an optimal policy is obtained during one or more training runs, the manager subsequently controls the environment according to the optimal policy. In other approaches, initial training generates an initial policy that is then continuously updated, along with the value function, in order to track changes in the environment so that a near-optimal policy is maintained by the manager.

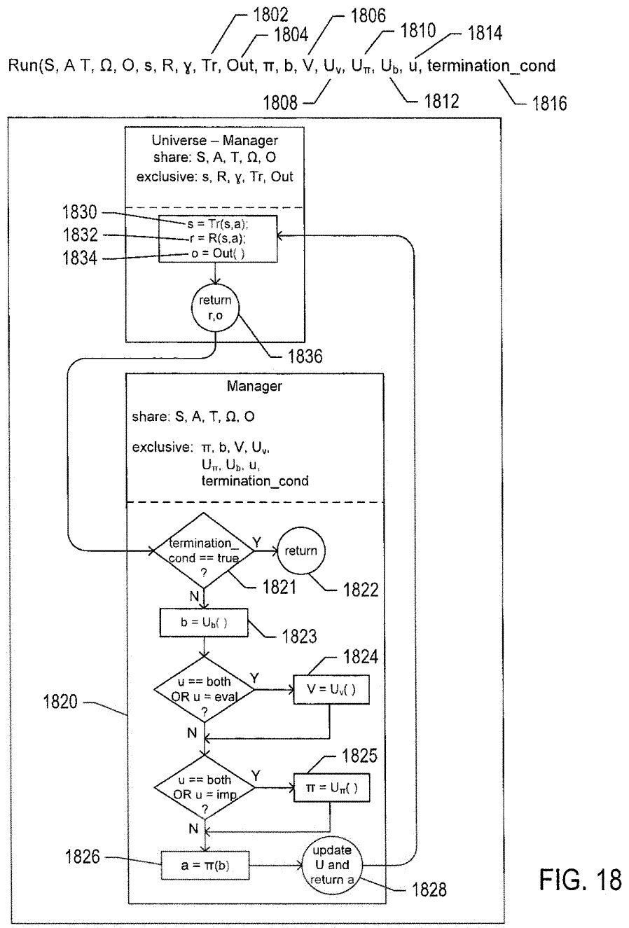

FIG. 18 provides a somewhat more detailed control-flow-like description of operation of the manager and environment than originally provided in FIG. 16A. The control-flow-like presentation corresponds to a run of the manager and environment that continues until a termination condition evaluates to TRUE. In addition to the previously discussed sets and functions, this model includes a state-transition function Tr 1802, an observation-generation function Out 1804, a value function V 1806, update functions U_{V} 1808, U_{π} 1810, and U_{b} 1812 that update the value function, policy, and belief distribution, respectively, an update variable u 1814 that indicates whether to update the value function, policy, or both, and a termination condition 1816. The manager 1820 determines whether the termination condition evaluates to TRUE, in step 1821, and, if so, terminates in step 1822. Otherwise, the manager updates the belief, in step 1823 and updates one or both of the value function and policy, in steps 1824 and 1825, depending on the current value of the update variable u. In step 1826, the manager generates a new action and, in step 1828, updates the update variable u and issues the generated action to the environment. The environment determines a new state 1830, determines a reward 1832, and determines an observation 1834 and returns the generated reward and observation in step 1836.

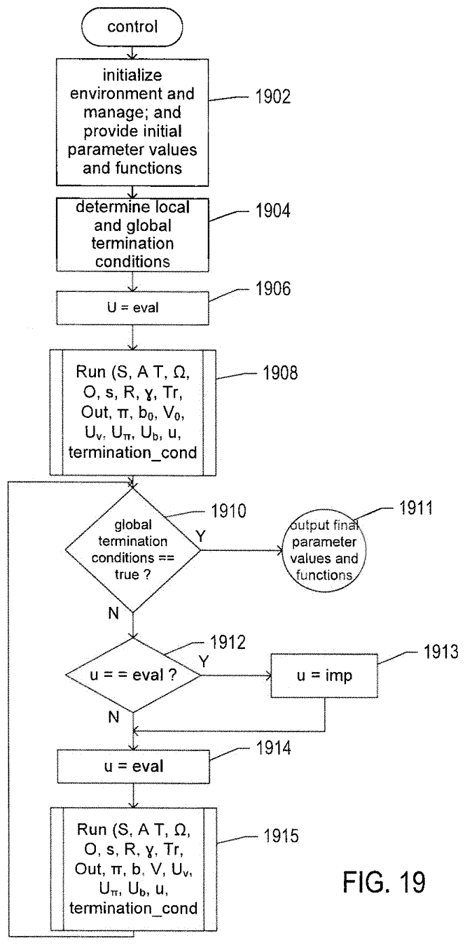

FIG. 19 provides a traditional control-flow diagram for operation of the manager and environment over multiple runs. In step 1902, the environment and manager are initialized. This involves initializing certain of the various sets, functions, parameters, and variables shown at the top of FIG. 18. In step 1904, local and global termination conditions are determined. When the local termination condition evaluates to TRUE, the run terminates. When the global termination condition evaluates to TRUE, operation of the manager terminates. In step 1906, the update variable u is initialized to indicate that the value function should be updated during the initial run. Step 1908 consists of the initial run, during which the value function is updated with respect to the initial policy. Then, additional runs are carried out in the loop of steps 1910-1915. When the global termination condition evaluates to TRUE, as determined in step 1910, operation of the manager is terminated in step 1911, with output of the final parameter values and functions. Thus, the manager may be operated for training purposes, according to the control-flow diagram shown in FIG. 19, with the final output parameter values and functions stored so that the manager can be subsequently operated, according to the control-flow diagram shown in FIG. 19, to control a live system. Otherwise, when the global termination condition does not evaluate to TRUE and when the update variable u has a value indicating that the value function should be updated, as determined in step 1912, the value stored in the update variable u is changed to indicate that the policy should be updated, in step 1913. Otherwise, the value stored in the update variable u is changed to indicate that the value function should be updated, in step 1914. Then, a next run, described by the control-flow-like diagram shown in FIG. 18, is carried out in step 1915. Following termination of this run, control flows back to step 1910 for a next iteration of the loop of steps 1910-1915. In alternative implementations, the update variable u may be initially set to indicate that both the value function and policy should be updated during each run and the update variable u is not subsequently changed. This approach involves different value-function and policy update functions than those used when only one of the value function and policy is updated during each run.

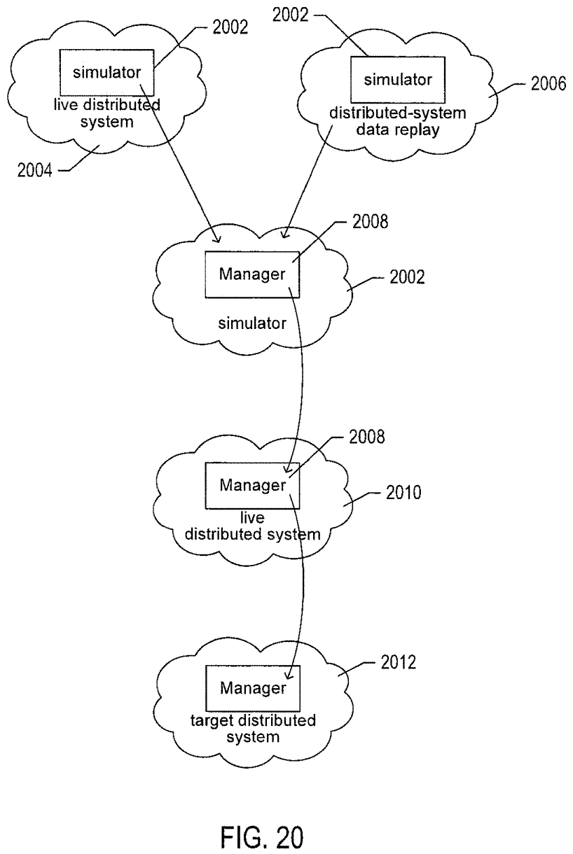

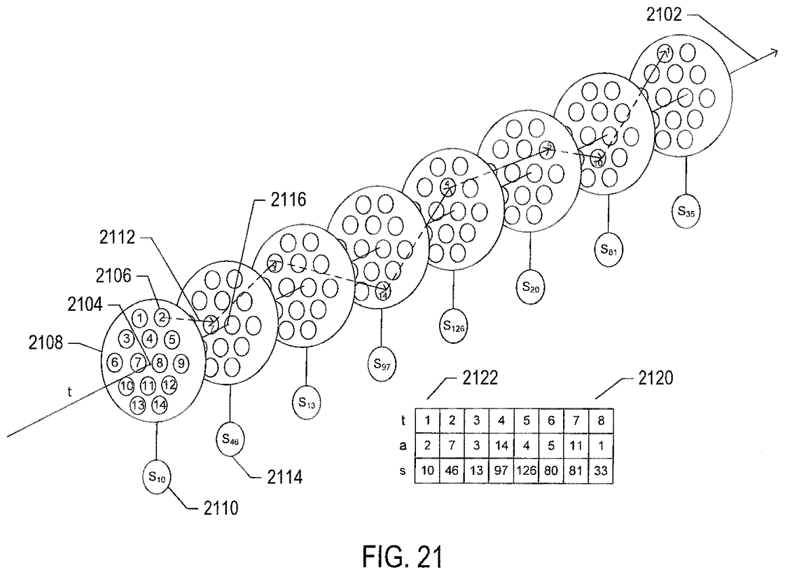

FIG. 20 illustrates one approach to using reinforcement learning to generate and operate an application manager. First, reinforcement learning is used to train an environment simulator 2002 by one or both of operating the simulator against a live-distributed-system environment 2004 or against a simulated distributed-system environment that replays archived data generated by a live distributed system to the simulator 2006. Then, a manager 2008 is initially trained by controlling an environment consisting of the simulator 2002. The manager, once trained, is then operated for a time to control an environment comprising a live distributed system 2010. Once the manager has been trained both against the simulator and the live distributed system, it is ready to be deployed to manage an environment 2012 comprising a target live distributed system.

FIG. 21 illustrates an alternative view of a control trajectory comprising a sequence of executed actions, each accompanied by a managed-environment state change. In FIG. 21, arrow 2102 represents a timeline. At the beginning of each of multiple time intervals, a reinforcement-learning-based controller, such as the currently disclosed safe-operation-constrained reinforcement-learning-based application manager subsequently referred to below as the “application manager,” invokes the above-discussed policy π to select a next action from a set of actions A. For example, at the time interval that begins with time 2104, the reinforcement-learning-based controller invokes the policy π to select action 2106, represented as a circle inscribing a numerical label “2,” from the set of possible actions A, represented by disk 2108, which contains 14 different possible actions represented by smaller circles that each inscribe a different numeric label. Of course, in real-world situations, there may be hundreds, thousands, tens of thousands, or more different possible actions. The state of the managed-environment, at time 2104, is represented by the circle 2110 inscribing the label “s₁₀” indicating the managed-environment state. When the reinforcement-learning-based controller executes the selected action, as represented by arrow 2112, the managed environment transitions to a new state 2114 at a next point in time 2116, where the process is repeated to produce a next action and next state transition. Thus, reinforcement-learning-based control can be thought of as a trajectory through a state action space. In the simple example of FIG. 21, with both actions and states represented by integers, the state/action space can be imagined as a two-dimensional plane with two orthogonal coordinate axes corresponding to actions and states. A control trajectory can be represented as a table, such as table 2120 shown in FIG. 21, containing three-value columns, such as column 2122, that each includes a time value, an indication of an action, and an indication of the state.

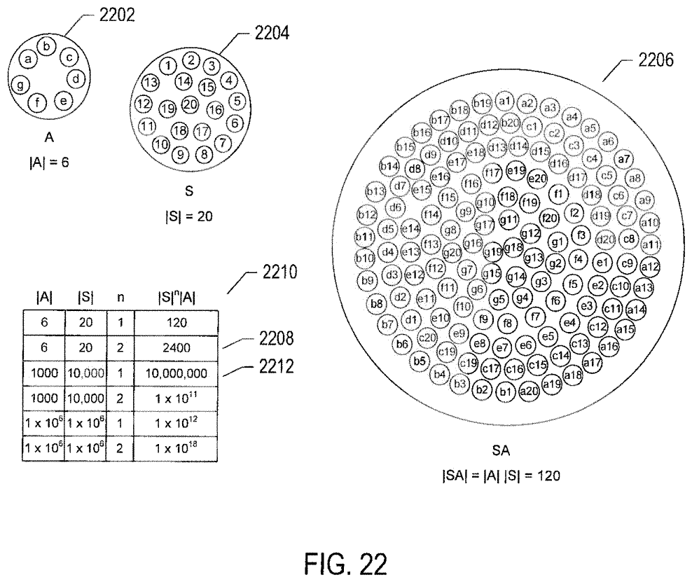

FIG. 22 illustrates the potential sizes of the set of possible state/action pairs. Using similar illustration conventions as used in FIG. 21, FIG. 22 shows an illustration of a set of actions A 2202, with a cardinality of 6, and a set of states S 2204, with a cardinality of 20. In certain reinforcement-learning-based controller implementations, the policy π is based on an assumed Markov model. In a Markov-model based policy, the policy π selects a next action based on the current managed-environment state or, when the state is unknown to the reinforcement-learning-based controller, on the belief distribution b for the current managed-environment state, as discussed above. The set of possible state/action pairs SA 2206 can be thought of as the set of all possible current-state/next-action control decisions that can be generated from the set of possible actions A and the set of possible states S. For a Markov-based reinforcement-learning-based controller, the number of possible state, action pairs is equal to the product of the cardinalities of the set of possible actions A and the set of possible states S. In the example shown in FIG. 22, the number of possible state action pairs is 120, even though there are only 6 possible actions and 20 possible states. Other types of reinforcement-learning-based controllers may consider the current state and the preceding state in order to choose a next action. In this case, each possible action-selection decision can be considered to be a triple comprising an action and two states. In this case, the number of possible control decisions is equal to the product of the cardinality of the set of possible actions A and the square of the cardinality of the set of possible states S. In yet other types of reinforcement-learning-based controllers, the n most recent states, including the current state, of the managed environment are considered when making an action-selection decision. The most general expression for the number of possible control decisions is: |S|ⁿ|A|. In the case that n equals 2, there are 2400 possible control decisions for the example shown in FIG. 22, as indicated in the second row 2208 of the table 2210 shown in FIG. 22. Of course, in real-world problem domains, there may be very large numbers of different possible actions and states. As shown in the third row 2212 of the table 2210, when there are 1000 possible actions and 10.000 possible states, a controller using a Markov policy, where n is equal to 1, includes 10,000,000 different possible control decisions. It would take on the order of many months of testing time for a controller, given these figures, to sample each possible control decision. For a controller using a policy based on a model for which n is equal to 2, with 1000 possible actions and 10,000 possible states, there are 10¹¹ different possible control decisions, which would take many thousands of years for the controller to sample once each. Thus, in practical, real-world situations, the number of possible control decisions, which represents the state space that a reinforcement-learning-based control system needs to explore in order to find an optimal policy, can be enormous.

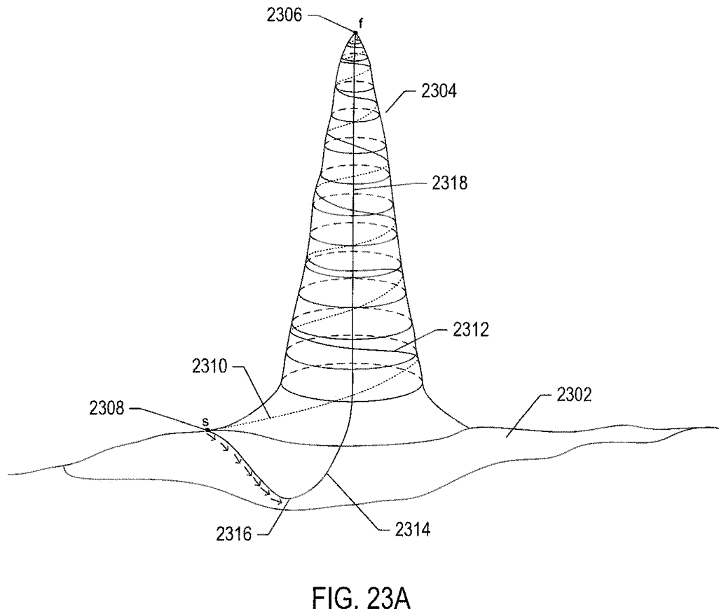

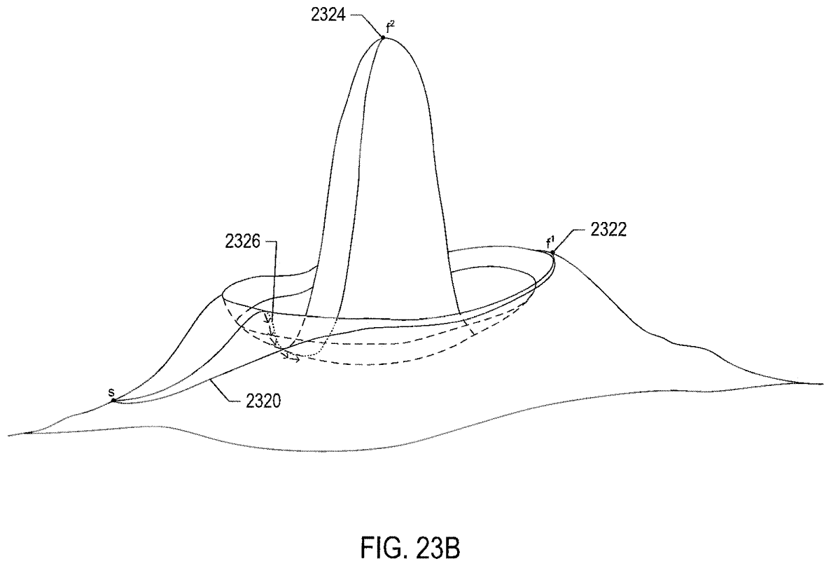

FIGS. 23A-B illustrate the need for state/action exploration by a reinforcement-learning-based controller. FIGS. 23A-B both use the same illustration conventions, next described with reference to FIG. 23A. A portion of a surface 2302 that represents the value or expected reward for state/action pairs includes a rather prominent peak 2304. The point at the summit of the surface 2306 represents a state/action pair that generates the greatest expected reward or value. In static environments, a reinforcement-learning-based controller, over time, seeks to obtain the maximum possible value by reaching point 2306, starting from an initial point 208. Two different trajectories are shown in FIG. 23A. In non-static environments, the controller seeks to obtain a maximum discounted reward over the most recent window in time. A first trajectory 2310 gradually ascends the peak, initially ascending the back side of the peak, wrapping around to the front side of the peak 2312, and slowly spiraling upward, continuously reaching higher-valued state/action pairs until reaching point 2306. A second trajectory 2314 initially descends to a lower point on the surface 2316 and then directly and steeply ascends 2318 to point 2306. In this case, if the number of actions needed to be taken in order to reach the optimal control decision is a measure of the efficiency of the reinforcement-learning-based controller, the second trajectory 2314 is by far most efficient. However, the second trajectory involves initially carrying out locally suboptimal actions of decreasing value. Of course, this is a somewhat artificial example and illustration, since trajectories would not generally map to quasi-continuous curves and would normally not continuously increase in value, but is intended to show that, unless the reinforcement-learning-based controller carries out a certain amount of state/action space exploration, the reinforcement-learning-based controller cannot discover optimal policies π*. In other words, were the reinforcement-learning-based controller to always select the currently most valuable action, and thus follow a greedy policy, the reinforcement-learning-based controller would generally fail to find the most efficient trajectories. As shown in FIG. 23B, in a different example, a greedy policy may allow a reinforcement-learning-based controller to find a trajectory 2320 that results in discovery of a locally optimal state/action pair 2322, but would not allow the reinforcement-learning-based controller to find the global optimal 2324, since all trajectories leading to the global optimum involve a stretch of non-optimal action selections 2326.

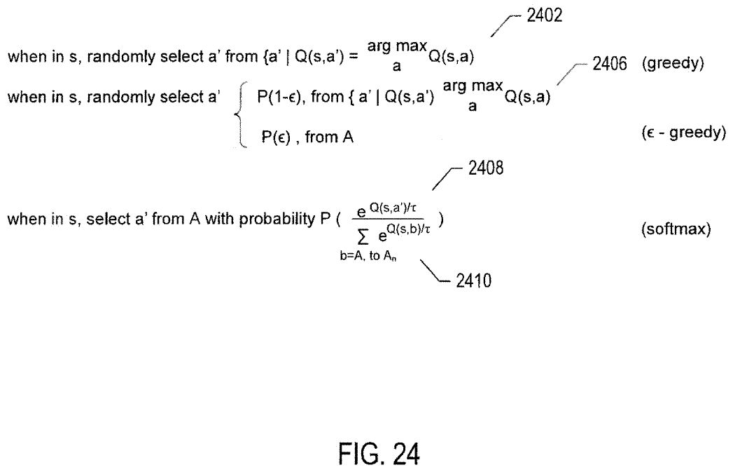

FIG. 24 provides expressions illustrating various types of policies. As discussed above, an action-value function Q^{π}(s,a) (1722 in FIG. 17) returns an estimated discounted total reward for a particular state and action, assuming a current policy π. A first expression 2402 represents the greedy policy. When the reinforcement-learning-based controller is in a state s, the greedy policy selects a next action a′ for which the estimated discounted total reward value is maximum among all possible actions a. As discussed above, the greedy policy generally does not allow a reinforcement-learning-based controller to efficiently find optimally efficient trajectories and optimal state/action pairs, and may not allow a reinforcement-learning-based controller to efficiently find optimally efficient trajectories regardless of the control/learning period during which the reinforcement-learning-based controller operates. The ϵ-greedy policy 2406 selects a next action a′ according to the greedy policy with a probability of 1−ϵ and selects a next action randomly from A with a probability of ϵ. In general, ϵ as a relatively low value, such as 0.1 or 0.01, so that, most of the time, the ϵ-greedy policy selects a next action with the maximum estimated discounted total reward value. However, occasionally, the ϵ-greedy policy randomly selects a next action, so that, over time, the reinforcement-learning-based controller tries a wide variety of the many possible control decisions. By exploring the state/action space, the reinforcement-learning-based controller gradually learns to assign accurate estimated discounted total reward values to the various different state/action pairs so that the policy can be optimized. The SoftMax policy 2408 randomly selects a next action a′ from A with the probability 2410, which corresponds to the Boltzmann distribution used in statistical mechanics. When the temperature factor τ has a low value, approaching 0, the probabilities of selection vary dramatically with the estimated discounted return for the state/action, but when the temperature factor τ has a large value, the differences in the probabilities of selection diminish. Like the ϵ-greedy policy, the SoftMax policy favors selection of an action with the greatest estimated discounted total reward value, but occasionally selects non-optimal actions in order to facilitate state/action space exploration.

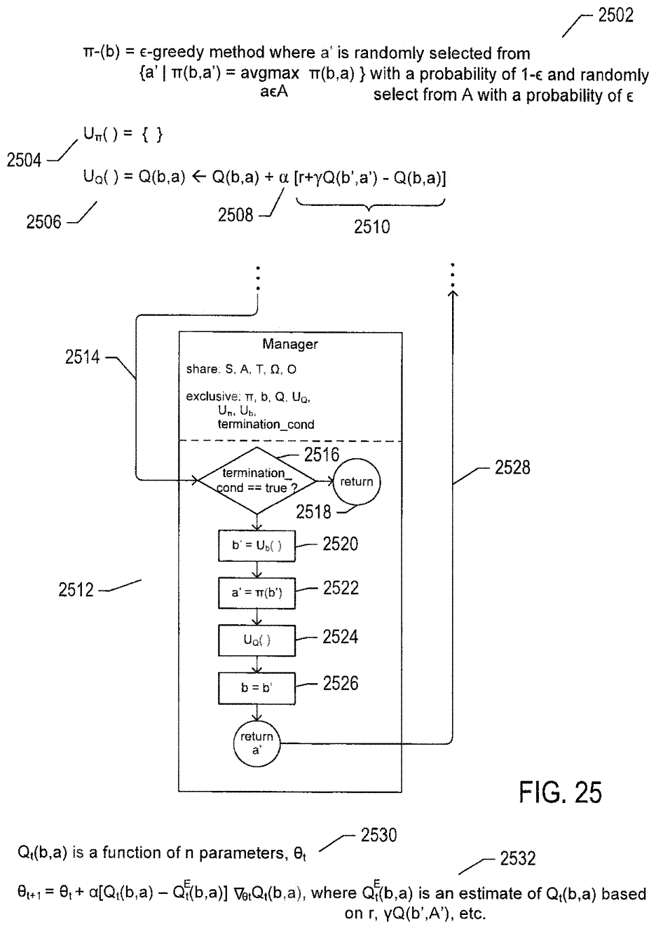

FIG. 25 illustrates one implementation of a reinforcement-learning-based application manager that employs state/action-space exploration via the above-discussed ϵ-greedy policy. As indicated by expression 2502, the policy employed by this implementation, π(b), selects a next action a′ with maximum estimated value with a probability of 1−ϵ and randomly selects the next action a′ from A the probability of ϵ, and is therefore an ϵ-greedy policy. In this implementation, as indicated by expression 2504, there is no explicit policy-update function, unlike the case in the implementation illustrated in FIG. 18. Instead, a state/action-value update function U_{Q}( ) 2506 is employed. This function updates the state/action value Q(b,a) by adding to the state/action value Q(b,a) the product of a learning rate α 2508 and an estimate of the most recent reward value 2510, where r is the reward received from executing action a, γ is the above-discussed discount rate, and b′ and a′ are the updated belief distribution and new selected action following execution of action a. Diagram 2512 illustrates the application manager logic that replaces the logic 1820 previously shown in FIG. 18. After execution of an action a, the universe returns the resulting reward r and observation vector o via path 2514. If the termination condition has occurred, as determined in step 2516, the application manager terminates, in step 2518. Otherwise, in step 2520, the application manager generates an updated belief distribution b′ using the belief-distribution-update function that, in turn, considers the returned observation vector returned by the managed environment, and, in step 2522, applies the policy (2502) to generate a next action a′ using the updated belief distribution b′. Then, in step 2524, the application manager updates the estimated discounted total reward value for the preceding action and belief distribution using the state/action-value update function 2506. In step 2526, the application manager stores the updated belief distribution as the current belief distribution and then returns the next action a′ to the managed environment via path 2528.

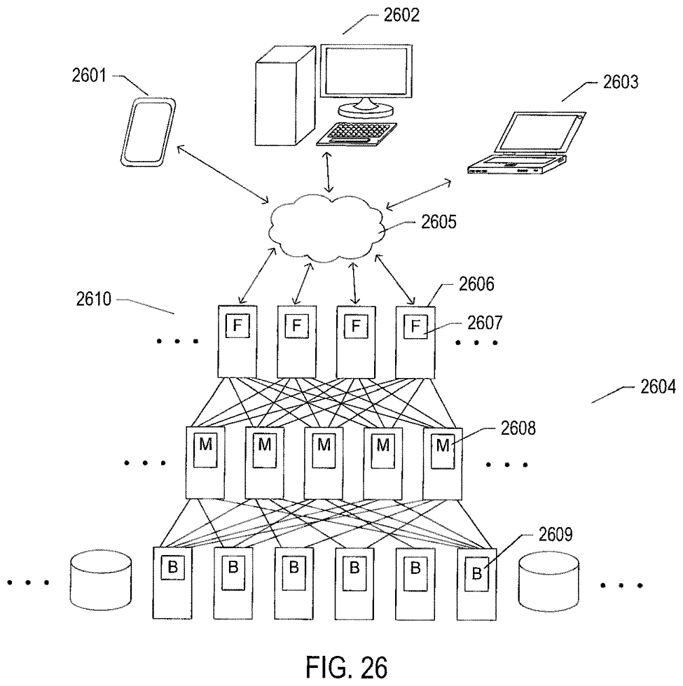

FIG. 26 illustrates a multi-level distributed application running within a distributed computer system that is accessed by external processor-controlled user devices. The external processor-controlled user devices 2601-2603 access the distributed application 2604 by calling distributed-application entrypoints via the Internet 2605 and a communication protocol, such as a Representational-State-Transfer (“REST”) protocol. The distributed application runs within a distributed computer system, such as the various different types of distributed computer systems discussed in the preceding subsection of this document. In general, the distributed computer system contains multiple server computers, such as server computer 2606, represented by rectangles in FIG. 26. Distributed-application components executing within servers are represented by smaller rectangles, such as rectangle 2607 within server 2606. An upper-case letter is used to indicate the type of distributed-application component. For example, distributed-application component 2607 is labeled with the upper-case letter “F” to indicate that it is a front-end-server component of the distributed application. Various other distributed-application components, such as a distributed-application component 2608, are labeled with the upper-case letter “M” to indicate that the components are middle-layer components. Additional distributed-application components, such as a distributed-application component 2609, are labeled with the upper-case letter “B” to indicate that the components are back-end components.

In FIG. 26, each row of servers, such as the first row of servers 2610, contains distributed-application components of a single type, representing a hierarchy of distributed-application-component types within the distributed computer system 2604. However, the actual physical locations of distributed-application components are generally not hierarchically distributed within the distributed computer system. In the example shown in FIG. 26, the distributed application includes front-end components, which communicate with external clients and users of the distributed application. The front-end components receive client requests, call various entrypoints of an internal API provided by the middle-layer distributed-application components in order to carry out the received requests, and return responses to the external users and clients. The middle-layer distributed-application components, in turn, call various entry points of an internal API provided by the back-end distributed-application components in order to access services and functionalities provided by the back-end distributed-application components, such as database access and searching and complex matrix operations. The front-end, middle-layer, and back-end components of the example distributed application shown in FIG. 26 comprise one example of a set of distributed-application components that together compose a distributed application. Other types of distributed applications may have many different distributed-application components that are not logically related to one another by a simple hierarchy, as is the case in FIG. 26. In fact, the decomposition of a distributed application into components may be somewhat arbitrary, in certain cases.

### First Implementation of an Example RL Agent

FIGS. 27A-B illustrate a simple example of a reinforcement-learning-based distributed-application manager/controller. The reinforcement-learning-based distributed-application manager/controller 2702 is referred to, below, as a reinforcement-learning agent (“RL agent”). The RL agent may be one of multiple different RL agents within a higher-level reinforcement-learning-based distributed-application manager/controller, each dedicated to managing and controlling a particular distributed application. This is assumed in the following discussion. However, in alternative implementations, an RL agent may simultaneously manage and control multiple different distributed applications. The distributed application controlled and managed by the RL agent includes three different types of distributed-application components 2704-2706, such as the front-end, middle-layer, and back-end components discussed above with reference to FIG. 26. These components are mapped to a set of virtual machines 2708 which provide execution environments for the components. The virtual machines are launched within a virtual data center 2710 that maps the virtual machines to physical servers within the underlying physical data center 2712. The RL agent 2702 issues actions, such as action 2714, to the management server 2716 for the virtual data center (“VDC”). In response to execution of an action, the RL agent is provided with a state 2718 and a reward 2720 based on metric data provided by the management server 2716. The RL agent executes on one or more virtual machines 2722 that are hosted by physical servers within the physical data center 2712. Thus, the RL agent controls and manages the distributed application by issuing various management commands to the management server 2716 and receives states and rewards from the management server following execution of the commands. As discussed above, in many implementations, an RL manager may interface not only to a VDC manager, but also to guest operating systems, virtualization layers, and other computational entities.

FIG. 27B illustrates the states and rewards received by the RL agent and the actions issued by the RL agent in greater detail. The VDC manager 2760 provides a metric interface 2730 and a control interface 2732. The metric interface 2730 provides current values of a variety of different metrics in response to metric requests. The different metrics for which values can be accessed via the metric interface are represented by the column vector M 2736. Each element of the column vector represents a different metric, and the value stored in an element represents the current value for the corresponding metric. The current values for the elements of a state vector 2738 representing the current state of the distributed application and the value for the current reward 2740 are each computed from one or more of the current metric values, as indicated by the arrows connecting elements of the metric vector 2736 to elements of the state vector 2738 and reward 2740. For certain state-vector elements, such as element 2742 of state vector 2738, the current value of the element is that of a single corresponding element 2744 of the metric column vector. For other state-vector elements, such as element 2746 of the state vector 2738, the value of the state-vector element is computed from the values of multiple metric values stored in multiple corresponding metric-column-vector elements 2748-2749. In FIG. 27B, an oval icon, such as oval icon 2750, represents a function that takes multiple metric-column-vector-element values as arguments and returns a computed or derived value for an element of the state vector or for the reward.

The vector representing an action 2752 generally contains multiple different sets of elements 2754-2756 that each represents a different management command 2757-2759. The commands are sequentially issued to the control interface 2732 of the VDC manager 2716, in the discussed implementations. There are many different possible mappings between action vectors and one or more management commands. In certain implementations, action vectors have fixed lengths and contain a fixed number of fixed-length management-command representations. In these implementations, management-command representations are padded, as necessary, in order to produce fixed-length representations. In certain implementations, only a single command is encoded within each action vector. In other implementations, an action vector may contain an arbitrary number of management-command representations up to some maximum number of management commands.

The example of a reinforcement-learning-based distributed-application manager/controller illustrated in FIGS. 27A-B is intentionally simplified to facilitate a subsequent discussion of the currently disclosed methods and systems. However, the currently disclosed methods and systems are applicable to more complex reinforcement-learning-based distributed-application managers, including reinforcement-learning-based distributed-application managers that interface to various types of control and management entities in addition to a VDC manager and reinforcement-learning-based distributed-application managers that manage and control multiple different distributed applications executing within multiple different distributed—the computer facilities.

FIGS. 28A-H illustrate operation of the RL agent discussed with reference to FIGS. 27A-B. As discussed in the preceding subsection of this document as well as above, with reference to FIGS. 27A-B, the RL agent 2800 issues actions 2801 to an environment 2801 and receives states and a reward 2802 from the environment in response to the issues actions. In the current example, the environment includes a distributed computing facility executing a distributed application, as discussed above with reference to FIGS. 27A-B. The RL agent includes an action-value function Q(s,a) 2803 that returns the estimated discounted total reward value for issuing action a to the environment when the environment is currently in state s. As discussed above, both actions and states are represented by vectors of values. The action-value function Q(s,a) is represented by a table in the first implementation discussed with reference to FIGS. 28A-H. The horizontal axis 2804 of the table represents different states and the vertical axis 2805 of the table represents actions. Action vectors and state vectors are mapped to indexes used to access state/action-pair elements in the tabular representation of the action-value function Q(s,a). Shaded elements in the table, such as element 2806, indicate disallowed state action pairs. The unshaded elements in each column represent the allowed actions for the state corresponding to the column. Note that the action-value function Q(s,a) differs from the action-value function discussed in the preceding subsection of this document. The RL agent implements a somewhat different type of reinforcement learning than that discussed in the preceding subsection of this document.

When the RL agent is launched, an initialization step 2807 is carried out, as discussed below. The initialization step produces an initial state and an initial action for issuance to the environment, represented by the indexes i and j representing a state/action-pair element in the tabular representation of the action-value function Q(s,a). Then, the RL agent continuously carries out the loop of steps 2808-2012. In step 2808, the RL agent executes, or issues, the currently selected action represented by index j. In step 2809, the RL agent requests metric data from the environment from which a reward r and a new state, represented by index p, are generated. In step 2810, the RL agent selects a next action, represented by index q. In step 2811, the action-value function Q(s,a) is updated based on the previous state/action pair represented by indexes i and j, the current-state/next-action pair represented by indexes p and q, and the reward r. In step 2812, which completes the current iteration of the loop of steps 2808-2812, the current state/action pair, represented by indexes i and j, is updated by being set to the state/action pair represented by indexes p and q. The action-value function Q(s,a) thus represents continuously learned information used by the RL agent to control and manage the distributed application.

FIG. 28B provides a control-flow diagram for a routine “initialize” that represents the initialization step 2807 shown in FIG. 28A. In step 2814, a routine “initialize Q” is called to initialize the contents of the tabular representation of the action-value function Q(s,a) (2803 and FIG. 28A). This initialization includes marking the disallowed state/action pairs and setting the contents of the elements corresponding to the allowed state/action pairs to some initial value. In step 2815, a routine “request metrics” is called to obtain the metric-value vector M discussed above with reference to FIG. 27B. In step 2816, a routine “generate current state vector s” is called to generate a current state vector from metric values in the metric-value vector M, as discussed with reference to FIG. 27B. In step 2817, the routine “determine state index” is called to generate an index i for the column of the tabular representation of the action-value function Q(s,a) corresponding to state s. Finally, a routine “select next action” is called, in step 2818, to generate an action index a for the first action that will be issued by the RL agent. Control-flow diagrams are not shown for the routines “initialize Q,” “request metrics,” “generate current state vector s,” and “determine state index,” called by the routine “initialize,” since their detailed implementations depend on particular implementation choices for state vectors and action vectors as well as the metric and command interfaces provided by the particular VDC manager to which the RL agent interfaces.

FIG. 28C provides a control-flow diagram for a routine “execute action” that represents the execution step 2808 shown in FIG. 28A. In step 2820, the routine “execute action” receives an action index i. In step 2021, local action-vector variable a is set to the action vector corresponding to action index i, where A is the set of all actions. In step 2022, a routine “generate management commands” decomposes the action vector a into a list or array of numCom management commands, commands. Then, in the for-loop of steps 2023-2027, each management command in the list or array commands is input to the VDC manager, via a call to the routine “input command to VDC manager” in step 2824, and the reward value received from the VDC manager, output by the routine “input command to VDC manager,” is input to the routine “handle response” in step 2025. This routine returns a Boolean value cont to indicate whether or not the remaining commands in the list or array of management commands, commands, should be issued to the VDC manager. The for-loop of steps 2023-2027 continues to iterate until either all of the commands corresponding to action vector a are issued or until the routine “handle response” returns the Boolean value FALSE as the return value cont.

FIG. 28D provides a control-flow diagram for the reward-and-state-fetching step 2809 shown in FIG. 28A. In step 2830, the routine “request metrics” is called to obtain the metric-value vector M. In step 2031, the routine “generate current state vector as” is called to generate a current state vector s. In step 2832, a routine “generate reward” is called to generate a reward r from metric values in the metric-value vector M. Finally, in step 2833, the routine “determine state index” is called to generate an index corresponding to the state vector s.

FIG. 28E provides a control-flow diagram for the routine “select next action” that represents the action-selection step 2810 shown in FIG. 28A. In step 2836, the routine “select next action” receives an index x corresponding to a state vector and generates a random number r in the range [0, 1]. When the random number r is less than the greedy parameter ε, as determined in step 2837, the local Boolean variable greedy is set to TRUE, in step 2838. Otherwise, in step 2839, the local Boolean variable greedy is set to FALSE. The Boolean variable greedy controls the routine “select next action” to either randomly select an action, for state/action-exploration purposes, from the set of actions A or to greedily select an action that produces a maximum estimated discounted total reward value when issued in the current state indexed by x. In step 2840, the local list variable bestA is initialized to the empty list, local index variable numBestA is initialized to 0, and local return-value variable bestQ is set to a minimum value. In the for-loop of steps 2841-2850, the actions that are valid for the state with index x are considered. The constant n is the number of actions in the set of actions A. When the currently considered action with index i is valid for state x, as determined in step 2842, control flows to step 2843. Otherwise, control flows to step 2849, from which another iteration of the for-loop of steps 2841-2850 may be undertaken. When the local Boolean variable greedy contains the value TRUE, as determined in step 2843, the currently considered action index i is added to the list bestA and the local variable numBestA is incremented, in step 2844. This represents state/action exploration. Otherwise, when the action-value function Q(s,a) returns an estimated discounted total reward value for the state/action pair corresponding to indexes x and i that is larger than the value stored in local variable bestQ, as determined in step 2845, local variable bestQ is set to the estimated discounted total reward value, local list variable bestA is cleared, and local variable numBestA is set to 0, in state 2847. Then, in step 2048, the currently considered action index i is added to the list bestA and local variable numBestA is incremented. Thus, bestA contains a list of actions that will return a maximum estimated discounted total reward value. Otherwise, when the action-value function Q(s,a) returns an estimated discounted total reward value for the state/action pair corresponding to indexes x and i that is equal to the value stored in local variable bestQ, as determined in step 2846, control flows to step 2848, described above, where the currently considered action index i is added to the list bestA and the local variable numBestA is incremented. Turning to FIG. 28F, following completion of the for-loop of steps 2841-2850, local variable i is set to index one of the action indexes stored in the local list variable bestA based on the random number r, in steps 2851-2853, and, in step 2854, the indexed action index is returned. In other words, the routine “select next action” randomly selects one of the indexes stored in local list variable bestA as the next action for issuance by the RL agent.

FIG. 28G provides a control-flow diagram for a routine “update Q” that represents the Q-update step 2811 shown in FIG. 28A. In step 2856, the routine “update Q” receives two pairs of state/action indexes i and j and p and q as well as a reward r. In step 2857, a total reward reward is set to r plus the estimated discounted total reward value returned by the action-value function Q(s,a) for the state/action pair corresponding to indexes p and q multiplied by a discount factor γ. This is the total estimated reward for having issued action j in state i. In step 2058, local variable Δ is set to a learning factor a times the difference between the value stored in local variable reward and the estimated discounted total reward value returned by the action-value function Q(s,a) for the state/action pair corresponding to indexes i and j. Finally, the element for the state/action pair corresponding to indexes i and j in the tabular representation of the action-value function Q(s,a) is updated by adding to the value stored in the element the value stored in local variable Δ, in step 2859.

FIG. 28H provides a control-flow diagram for step 2812 shown in FIG. 28A. This routine simply sets the state/action index pair i and j to the value stored in index pair p and q.

### Neural Networks

FIG. 29 illustrates fundamental components of a feed-forward neural network. Equations 2902 mathematically represent ideal operation of a neural network as a function f(x). The function receives an input vector x and outputs a corresponding output vector y 2903. For example, an input vector may be a digital image represented by a two-dimensional array of pixel values in an electronic document or may be an ordered set of numeric or alphanumeric values. Similarly, the output vector may be, for example, an altered digital image, an ordered set of one or more numeric or alphanumeric values, an electronic document, or one or more numeric values. The initial expression 2903 represents the ideal operation of the neural network. In other words, the output vectors y represent the ideal, or desired, output for corresponding input vector x. However, in actual operation, a physically implemented neural network \hat{f}(x), as represented by expressions 2904, returns a physically generated output vector ŷ that may differ from the ideal or desired output vector y. As shown in the second expression 2905 within expressions 2904, an output vector produced by the physically implemented neural network is associated with an error or loss value. A common error or loss value is the square of the distance between the two points represented by the ideal output vector and the output vector produced by the neural network. To simplify back-propagation computations, discussed below, the square of the distance is often divided by 2. As further discussed below, the distance between the two points represented by the ideal output vector and the output vector produced by the neural network, with optional scaling, may also be used as the error or loss. A neural network is trained using a training dataset comprising input-vector/ideal-output-vector pairs, generally obtained by human or human-assisted assignment of ideal-output vectors to selected input vectors. The ideal-output vectors in the training dataset are often referred to as “labels.” During training, the error associated with each output vector, produced by the neural network in response to input to the neural network of a training-dataset input vector, is used to adjust internal weights within the neural network in order to minimize the error or loss. Thus, the accuracy and reliability of a trained neural network is highly dependent on the accuracy and completeness of the training dataset.

As shown in the middle portion 2906 of FIG. 29, a feed-forward neural network generally consists of layers of nodes, including an input layer 2908, an output layer 2910, and one or more hidden layers 2912 and 2914. These layers can be numerically labeled 1, 2, 3, . . . , L, as shown in FIG. 29. In general, the input layer contains a node for each element of the input vector and the output layer contains one node for each element of the output vector. The input layer and/or output layer may have one or more nodes. In the following discussion, the nodes of a first level with a numeric label lower in value than that of a second layer are referred to as being higher-level nodes with respect to the nodes of the second layer. The input-layer nodes are thus the highest-level nodes. The nodes are interconnected to form a graph.

The lower portion of FIG. 29 (2920 in FIG. 29) illustrates a feed-forward neural-network node. The neural-network node 2922 receives inputs 2924-2927 from one or more next-higher-level nodes and generates an output 2928 that is distributed to one or more next-lower-level nodes 2930-2933. The inputs and outputs are referred to as “activations,” represented by superscripted-and-subscripted symbols “a” in FIG. 29, such as the activation symbol 2934. An input component 2936 within a node collects the input activations and generates a weighted sum of these input activations to which a weighted internal activation a₀ is added. An activation component 2938 within the node is represented by a function g( ) referred to as an “activation function,” that is used in an output component 2940 of the node to generate the output activation of the node based on the input collected by the input component 2936. The neural-network node 2922 represents a generic hidden-layer node. Input-layer nodes lack the input component 2936 and each receive a single input value representing an element of an input vector. Output-component nodes output a single value representing an element of the output vector. The values of the weights used to generate the cumulative input by the input component 2936 are determined by training, as previously mentioned. In general, the input, outputs, and activation function are predetermined and constant, although, in certain types of neural networks, these may also be at least partly adjustable parameters. In FIG. 29, two different possible activation functions are indicated by expressions 2940 and 2941. The latter expression represents a sigmoidal relationship between input and output that is commonly used in neural networks and other types of machine-learning systems.

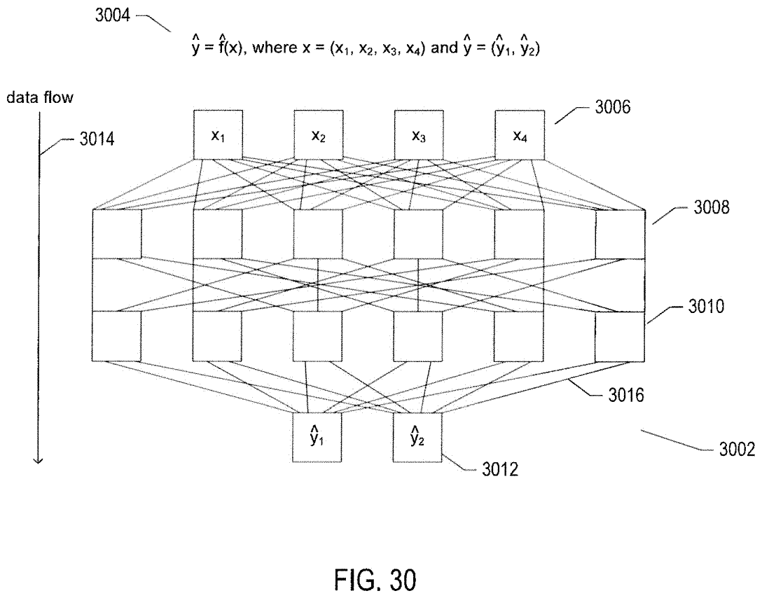

FIG. 30 illustrates a small, example feed-forward neural network, illustrates a small, example feed-forward neural network. The example neural network 3002 is mathematically represented by expression 3004. It includes an input layer of four nodes 3006, a first hidden layer 3008 of six nodes, a second hidden layer 3010 of six nodes, and an output layer 3012 of two nodes. As indicated by directed arrow 3014, data input to the input-layer nodes 3006 flows downward through the neural network to produce the final values output by the output nodes in the output layer 3012. The line segments, such as line segment 3016, interconnecting the nodes in the neural network 3002 indicate communications paths along which activations are transmitted from higher-level nodes to lower-level nodes. In the example feed-forward neural network, the nodes of the input layer 3006 are fully connected to the nodes of the first hidden layer 3008, but the nodes of the first hidden layer 3008 are only sparsely connected with the nodes of the second hidden layer 3010. Various different types of neural networks may use different numbers of layers, different numbers of nodes in each of the layers, and different patterns of connections between the nodes of each layer to the nodes in preceding and succeeding layers.

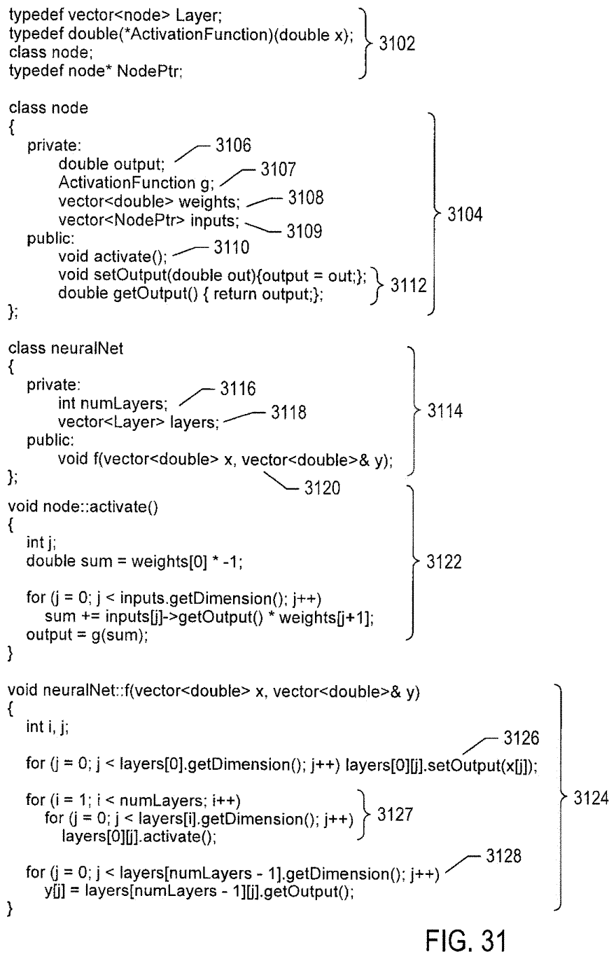

FIG. 31 provides a concise pseudocode illustration of the implementation of a simple feed-forward neural network. Three initial type definitions 3102 provide types for layers of nodes, pointers to activation functions, and pointers to nodes. The class node 3104 represents a neural-network node. Each node includes the following data members: (1) output 3106, the output activation value for the node: (2) g 3107, a pointer to the activation function for the node (3) weights 3108, the weights associated with the inputs; and (4) inputs 3109, pointers to the higher-level nodes from which the node receives activations. Each node provides an activate member function 3110 that generates the activation for the node, which is stored in the data member output, and a pair of member functions 3112 for setting and getting the value stored in the data member output. The class neuralNet 3114 represents an entire neural network. The neural network includes data members that store the number of layers 3116 and a vector of node-vector layers 3118, each node-vector layer representing a layer of nodes within the neural network. The single member function f 3120 of the class neuralNet generates an output vector y for an input vector x. An implementation of the member function activate for the node class is next provided 3122. This corresponds to the expression shown for the input component 2936 in FIG. 29. Finally, an implementation for the member function f 3124 of the neuralNet class is provided. In a first for-loop 3126, an element of the input vector is input to each of the input-layer nodes. In a pair of nested for-loops 3127, the activate function for each hidden-layer and output-layer node in the neural network is called, starting from the highest hidden layer and proceeding layer-by-layer to the output layer. In a final for-loop 3128, the activation values of the output-layer nodes are collected into the output vector y.

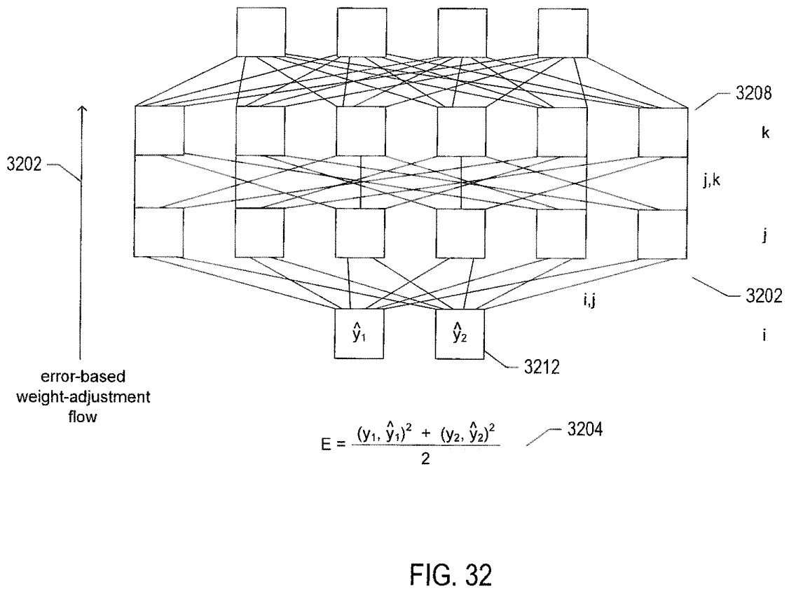

FIG. 32 illustrates back propagation of errors through a neural network during training. As indicated by directed arrow 3202, the error-based weight adjustment flows upward from the output-layer nodes 3012 to the highest-level hidden-layer nodes 3008. For the example neural network 3002, the error, or loss, is computed according to expression 3204. This loss is propagated upward through the connections between nodes in a process that proceeds in an opposite direction from the direction of activation transmission during generation of the output vector from the input vector. The back-propagation process determines, for each activation passed from one node to another, the value of the partial differential of the error, or loss, with respect to the weight associated with the activation. This value is then used to adjust the weight in order to minimize the error, or loss.

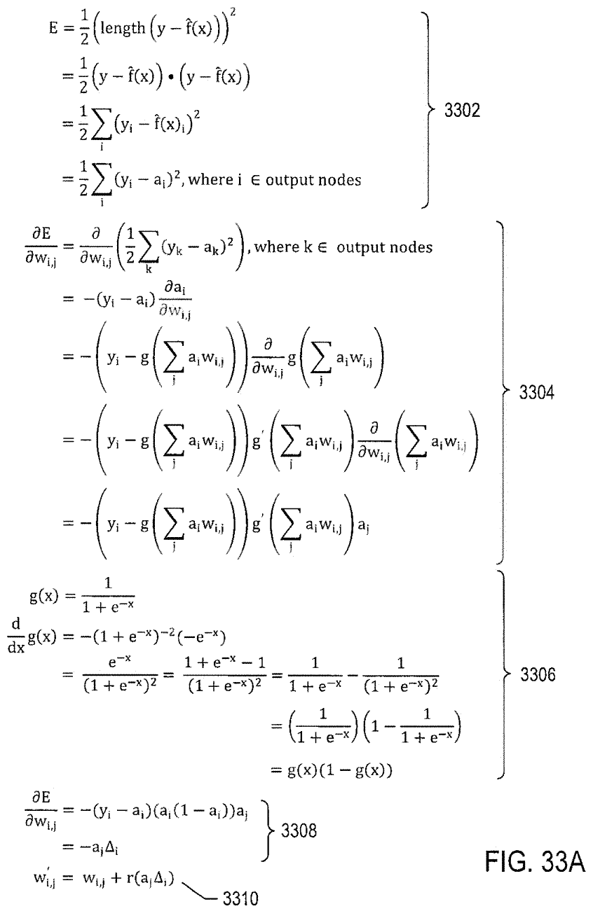

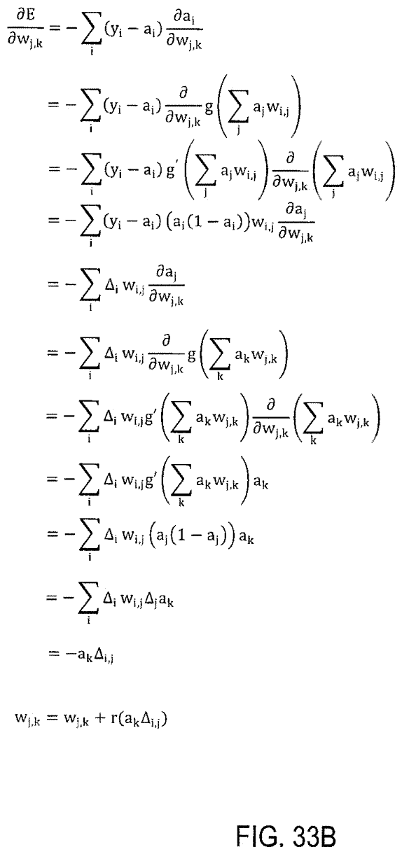

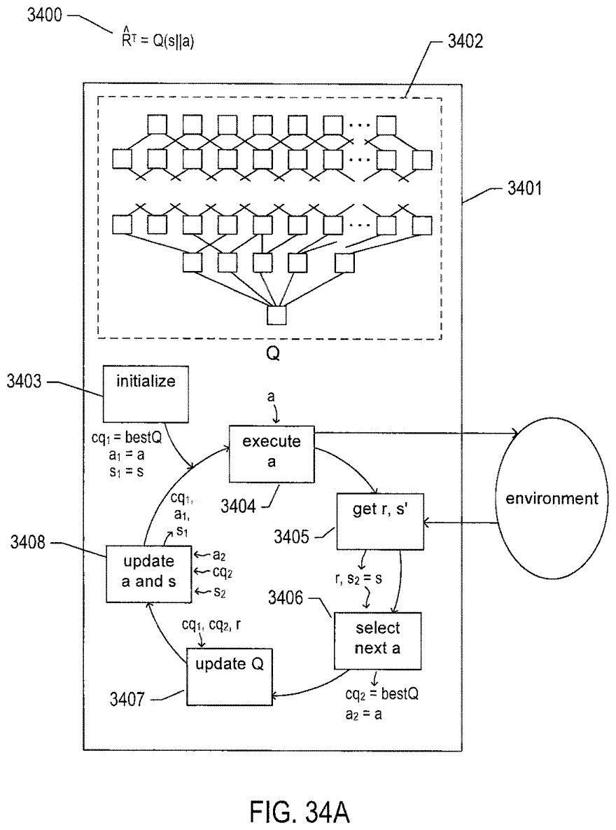

FIGS. 33A-B show the details of the weight-adjustment calculations carried out during back propagation. FIGS. 33A-B show the details of the weight-adjustment calculations carried out during back propagation. An expression for the total error, or loss. E with respect to an input-vector/label pair within a training dataset is obtained in a first set of expressions 3302, which is one half the squared distance between the points in a multidimensional space represented by the ideal output and the output vector generated by the neural network. The partial differential of the total error E with respect to a particular weight w_{i,j} for the j^{th} input of an output node i is obtained by the set of expressions 3304. In these expressions, the partial differential operator is propagated rightward through the expression for the total error E. An expression for the derivative of the activation function with respect to the input x produced by the input component of a node is obtained by the set of expressions 3306. This allows for generation of a simplified expression for the partial derivative of the total energy E with respect to the weight associated with the j^{th} input of the i^{th} output node 3308. The weight adjustment based on the total error E is provided by expression 3310, in which r has a real value in the range [0-1] that represents a learning rate, aⱼ is the activation received through input j by node i, and Δᵢ is the product of parenthesized terms. which include aᵢ and yᵢ, in the first expression in expressions 3308 that multiplies aⱼ. FIG. 33B provides a derivation of the weight adjustment for the hidden-layer nodes above the output layer. It should be noted that the computational overhead for calculating the weights for each next highest layer of nodes increases geometrically, as indicated by the increasing number of subscripts for the Δ multipliers in the weight-adjustment expressions.

### Second Implementation of the Example RL Agent

FIGS. 34A-G illustrate an alternative implementation of the RL agent that uses a neural-network function approximator for the action-value function Q(s,a) rather than the tabular representation used in the implementation discussed above with reference to FIGS. 28A-H. It is common to use a neural-network function approximator for the action-value function Q(s,a) when the cardinalities of the set of actions A and the set of possible states S are too large for implementation as a table. As indicated by expression 3400 at the top of FIG. 34A, the neural-network function approximator for the action-value function Q(s,a) receives, as input, a concatenation of a state vector and an action vector and returns an estimated discounted total reward value for issuing the action corresponding to the action vector when the environment is in the state corresponding to the state vector. The RL agent 3401 includes the neural-network function approximator (“Q”) for the action-value function Q(s,a) 3402, an initialization step 3403, and a continuous loop of steps 3404-3408, equivalent to the tabular representation for the action-value function Q(s,a) 2803, initialization step 2807, and the continuous loop of steps 2808-2812 in the RL agent 2800 shown in FIG. 28A. The only differences in the implementation of RL agent 3401 shown in FIG. 34A with respect to the first implementation shown in FIG. 28A is the use of the neural-network function approximator for the action-value function Q(s,a) rather than the tabular representation of the action-value function Q(s,a) and use of state and action vectors rather than indexes corresponding to state and action vectors.

FIGS. 34B-G provide control-flow diagrams for the initialization step 3403, the next-action-selection step 3406, the state-and-reward fetching step 3405, and the two update steps 3407 and 3408. The logic in these control-flow diagrams is essentially identical to the logic in the corresponding control-flow diagrams for the first implementation of the RL agent shown in FIGS. 28A-H, and these control-flow diagrams are not therefore discussed in detail. For example, implementation of the routine “initialize,” shown in FIG. 34B, is similar to implementation of the routine “initialize,” shown in FIG. 28B. The only differences are that there is no need for the routine “determine state index,” called in step 2817 of FIG. 28B, in the implementation of the routine “initialize” shown in FIG. 34B, since the implementation of the RL agent illustrated in FIGS. 34A-G uses state vectors and action vectors, rather than indexes, for calling the action-value function Q(s,a). In addition, the routine “select next action,” called in step 3412 in FIG. 34B, returns an estimated discounted total reward value obtained by calling the action-value function Q(s,a) as well as an action vector, rather than an index pair, as in the implementation shown in FIG. 28B. The routine “execute action,” representing step 2808 in FIG. 28A and step 3404 in FIG. 34A, is identical in both implementations. The implementation of the routine “select next action,” shown in FIGS. 34C-D, is essentially identical to the implementation of the routine “select next action” shown in FIGS. 28A-F, with the exception that a concatenation of a state vector and action vector are supplied as input to the neural-network-implemented action-value function Q(s,a) in the implementation of the routine shown in FIGS. 34C-D. Similar comments apply to the remaining routines that implement RTL-agent continuous-loop of steps in the implementation discussed with reference to FIGS. 34A-G, with one notable exception. In the implementation of the routine “update Q,” shown in FIG. 34F, a loss Δ² is backpropagated, in step 3414, into the neural-network function approximator rather than carrying out the table-entry update in step 2859 of FIG. 28G.

Incorporation of neural-network function approximators into RL agents in place of tabular representations of functions, such as the action-value function Q(s,a), is therefore relatively straightforward. The example RL agent discussed with reference to FIGS. 27A-28 H and FIGS. 34A-G uses only a single action-value function Q(s,a). Other types of reinforcement-learning-based agents and systems may employ multiple different functions, including state-value functions, belief distributions, transition-probability distributions, and other functions in addition to, or instead of, action-value functions. In addition, various implementations may decompose one or more of these functions into multiple component functions. In many, if not all, cases, tabular representations of reinforcement-learning functions, efficient and useful in certain low-complexity applications, can be replaced by various types of function approximators, including neural-network function approximators.

### Currently Disclosed Methods and Systems

Reinforcement-learning-based application managers, as mentioned above, represent significant improvements in the capabilities, efficiencies, and cost effectiveness of application managers, since, during operation, they automatically learn how to optimally or near optimally manage and control applications in order to meet or exceed various key-performance-metric-based constraints and goals. As discussed above, modern, complex distributed applications have become far too complex to manage and control using rule-based policies and hard-coded logic. However, in order to learn, reinforcement-learning-based application managers need to explore the state and action spaces and thus, inevitably, make and learn from suboptimal decisions and mistakes. Incorporating neural-network-based function approximators into reinforcement-learning-based application managers can introduce yet an additional learning level and add to the duration of the learning process. Mistakes and suboptimal control may be unacceptable to owners, managers, and users of distributed applications. Therefore, methods for decreasing the initial intervals during which reinforcement-learning-based application managers are prone to suboptimal control are needed in order to improve both reinforcement-learning-based application managers as well as the distributed computer systems hosting distributed applications they manage to a point at which they become more widely acceptable to owners, managers, and users of distributed applications and distributed computer systems. Ultimately, reinforcement-learning-based applications managers need to be improved to a level at which the disadvantages of the initial learning period are far outweighed by the advantages ultimately provided by reinforcement-learning-based application management and control. In addition, it is also desirable to improve the overall effectiveness of the control of distributed applications and distributed computer systems by reinforcement-learning-based application managers, as indicated by the rewards returned by the environment to the reinforcement-learning agent or controller incorporated within the reinforcement-learning-based application managers. In general, were the reinforcement-learning agent or controller to initially issue actions that resulted in larger rewards, the reinforcement-learning agent or controller could often not only learn an adequate control policy more quickly, but could additionally learn a better control policy at each point in time following initial launch of the reinforcement-learning-based application manager.

FIGS. 35A-B illustrate function-approximator decomposition with respect to distributed-application components. As shown in FIG. 35A, the above-discussed RL agent manages and controls a distributed application that includes multiple instances of a front-end component 3502, multiple instances of a middle-layer component 3504 and multiple instances of a backend component 3506. The reinforcement-learning method used by the RL agent includes a neural-network function approximator for the action-value function Q(s,a) 3508, an action-vector space 3510 that represents all possible actions, and a state-vector space S 3512 that represents all possible states. The RL agent issues actions to a VDC manager, in the described implementation, and receives a current state vector and reward generated from metrics received from the VDC manager. This is a rather monolithic approach to management and control of the distributed application. This approach also constrains the ability for vendors and users of reinforcement-learning-based application managers to benefit from a previously trained function approximator for the action-value function Q(s,a). Because, in general, the learned discounted total reward value for state/action pairs are nonuniformly distributed across the weights associated with nodes in the neural-network function approximator, and because the weights are highly dependent on the exact configuration of the environment being managed and controlled by the reinforcement-learning-based application manager, the control information learned, over time, by an existing reinforcement-learning-based application manager and encoded in the neural-network function approximator for the action-value function Q(s,a) cannot be effectively transferred to a new reinforcement-learning-based application manager that is intended for managing and controlling a differently configured environment. For example, the new reinforcement-learning-based application manager may be intended to manage and control a distributed application that includes the same or similar middle-layer and back-end components as a different, existing distributed application, but that includes a front-end component that differs from the front-end component of the existing distributed application. In this case, the trained function approximator within the existing distributed application is unlikely to be effectively incorporated into the new distributed application because the optimal or near optimal control strategy for the new distributed application is likely to differ significantly from that learned by the RL agent for the existing distributed application and because the differences cannot be mapped to specific changes in the weights associated with nodes of the trained function approximator.

FIG. 35B shows a distributed-application-component-based decomposition of the action space A, state space S, and function approximator Q. In this decomposition, each of the front-end 3502, middle-layer 3504, and back-end 3506 components of the distributed application are associated with a component-specific action space, state space, and function approximator. For example, the front-end component 3502 is associated with a front-end-specific action space 3520, state space 3522, and function approximator 3524. The different component-specific action spaces and state spaces may overlap, to varying extents for different types and implementations of distributed-application components. Nonetheless, many of the elements in action vectors and state vectors may be particular to one or a subset of the distributed-application components, so that the cardinalities of the component-specific action spaces and state spaces may be significantly smaller than those for the monolithic action space and state space discussed above with reference to FIG. 35A. Importantly, the component-specific function approximators are trained, over time, to learn component-specific estimated discounted total reward values for component-specific state/action pairs. The distributed-application-component-based decomposition of the action space A, state space S, and function approximator Q, if properly incorporated within reinforcement-learning-based RL agents, can therefore be used to address the problem domain discussed in the preceding paragraph. In the example discussed in that paragraph, the trained function approximators for the middle-layer component and back-end component of the existing distributed application can be incorporated into the function approximator employed by the RL agent for the new distributed application. Only the front-end-specific function approximator would then be initially untrained. Therefore, much of the learned control and management knowledge of the RL agent for the existing distributed application is transferred to the function approximator that will be used by the RL agent for the new distributed application. The RL agent for the new distributed application needs to learn an optimal or near optimal strategy for controlling and managing the front-end component of the new distributed application, significantly shortening the initial learning period for the RL agent for the new distributed application and increasing RL agent performance both initially and over the duration of the RL agent's operation.

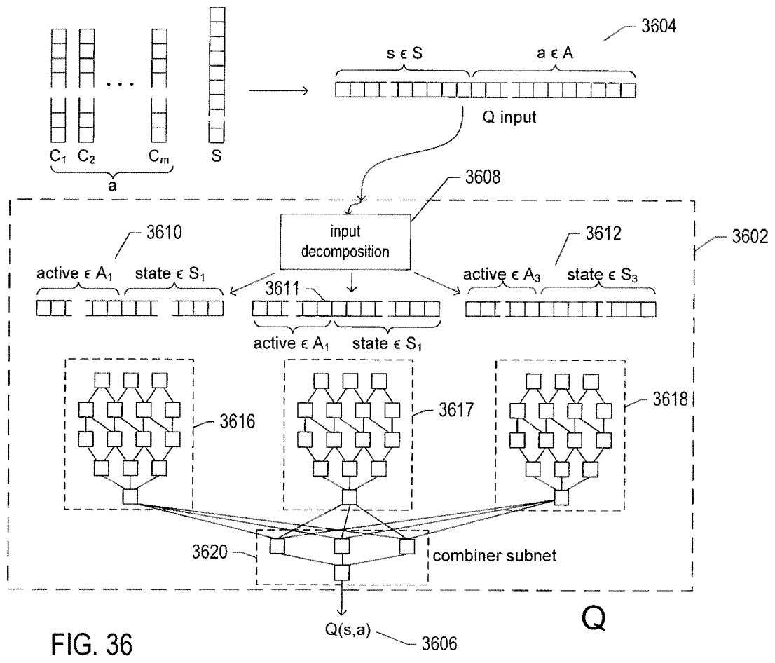

The question is then how to incorporate the distributed-application-component-based decomposition of the action space A, state space S, and function approximator Q shown in FIG. 35B into the example RL agent discussed above with reference to FIGS. 34A-G. FIG. 36 illustrates an efficient method by which distributed-application-component-based decomposition can be incorporated within an RL agent, including the example RL agent discussed above with reference to FIGS. 34A-G. The composite function approximator Q 3602 takes, as input, the same concatenated state/action pair 3604 as input to the monolithic function approximator Q (3402 in FIG. 34A) and outputs an estimated discounted total reward value for the input states action pair 3606 equivalent to the output from the monolithic function approximator Q (3402 in FIG. 34A). Thus, the composite function approximator Q 3602 can straightforwardly replace the monolithic function approximator Q discussed above in the RL-agent implementation shown in FIGS. 34A-G. No changes to the logic of the continuous-loop of steps carried out by the RL agent are needed. The composite function approximator Q 3602 includes input-decomposition logic 3608 that decomposes the input concatenated state, action pair into component-specific concatenated state/action pairs 3610-3612. Implementation of the input-decomposition logic 3608 depends on the types and numbers of distributed-application components as well as the particular methods by which action vectors are constructed from component commands and state vectors are constructed from metric values. The decomposition of input concatenated state/action pairs is directly related to the decomposition illustrated in FIG. 35B, and relies on knowledge of the component-specific action spaces and state spaces. The decomposition may itself be implemented by machine-learning-based decomposition-function approximators, in certain cases, or implemented using action-space and state-space tables, in certain low-complexity applications. The component-specific approximator functions may share a common, parameterized configuration or may have component-specific configurations. The component-specific concatenated state/action pairs 3610-3612 generated by the input-decomposition logic 3608 are each input to a corresponding component-specific function approximator 3616-3618. Outputs from the component-specific function approximators are combined, via a small combiner subnet 3622, to produce a return-value output 3606. Because the composite neural network is a neural network containing nodes associated with weights, backpropagation of loss values is carried out as for any other neural network, independently from the input-decomposition logic 3608.

When there are no pre-trained component-specific function approximators, the component-specific function approximators within the composite function approximator 3602 are initialized with initial weight values in the same way that the monolithic function approximator is initialized. When there is an existing distributed application with identical components and a similar configuration as that of a new distributed application, the pre-trained monolithic function approximator from the RL agent controlling the existing distributed application can be directly imported into a new RL agent intended to control the new distributed application. When there are existing distributed applications that include components used in a new distributed application, pre-trained component-specific function approximators can be imported into the composite function approximator within a new RL agent intended to control the new distributed application. Those distributed-application components of the new distributed application for which no pre-trained component-specific function approximators can be found can be initialized with initial weights and trained during an initial period of operation of the RL agent intended to control the new distributed application.

While the described example RL agent and distributed application uses a single neural-network function approximator for the action-value function Q(s,a), other reinforcement-learning-based application managers may employ additional and/or different function approximators for additional and/or different reinforcement-learning functions. For neural-network approximators, composite neural-network approximators are generated similar to the above-described composite function approximator for the action-value function Q(s,a). In most cases, the component-specific action and/or state spaces are employed for decomposing one or more arguments supplied to the reinforcement-learning functions into component-specific inputs to the component-specific neural-networks that together compose the composite function approximators. Similar types of composite function approximators can be generated for other types of machine-learning entities, such as decision trees, rule-induction systems, and other machine-learning entities.

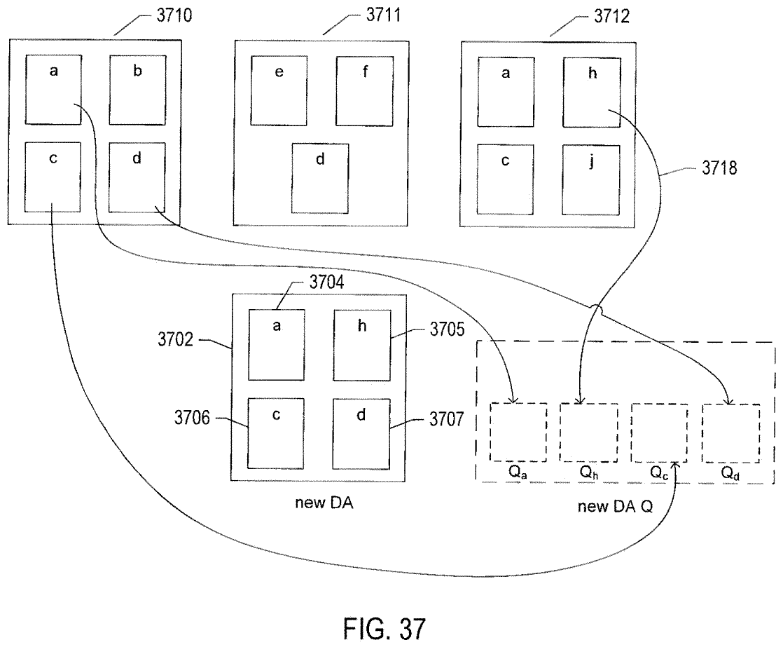

FIG. 37 illustrates composition of a composite function approximator for a new distributed application using pre-trained component-specific function approximators extracted from RL agents controlling existing distributed applications. The new distributed application 3702 includes four different components 3704-3707. Existing distributed applications 3710-3712 have component compositions that differ from the new distributed application, but, in the aggregate, contain components of the same types as contained in the new distributed application. Thus, the composite function approximator 3716 for the RL agent intended to control the new distributed application can be assembled from pre-trained component-specific function approximators within RL agents that control the existing distributed applications. The curved arrows, such as arrow 3718, indicate which of the component-specific function approximators within RL agents controlling the existing distributed applications are used to compose the composite function approximator 3716 for the new distributed application. The choice of which pre-trained component-specific function approximators to use may be complicated. In the example shown in FIG. 37, the pre-trained component-specific function approximators for components a, c, and d of the new distributed application are shown to be taken from existing distributed application 3710, even though each of the remaining existing distributed applications also contain these components. The reasoning may be that it is better to take as many pre-trained component-specific function approximators from a single existing distributed application as possible, so that any cross-component training is imported into the new composite function approximator. Many other considerations may also apply. For example, pre-trained component-specific function approximators may be selected from existing distributed applications with configurations closest to the configuration of the new distributed application.

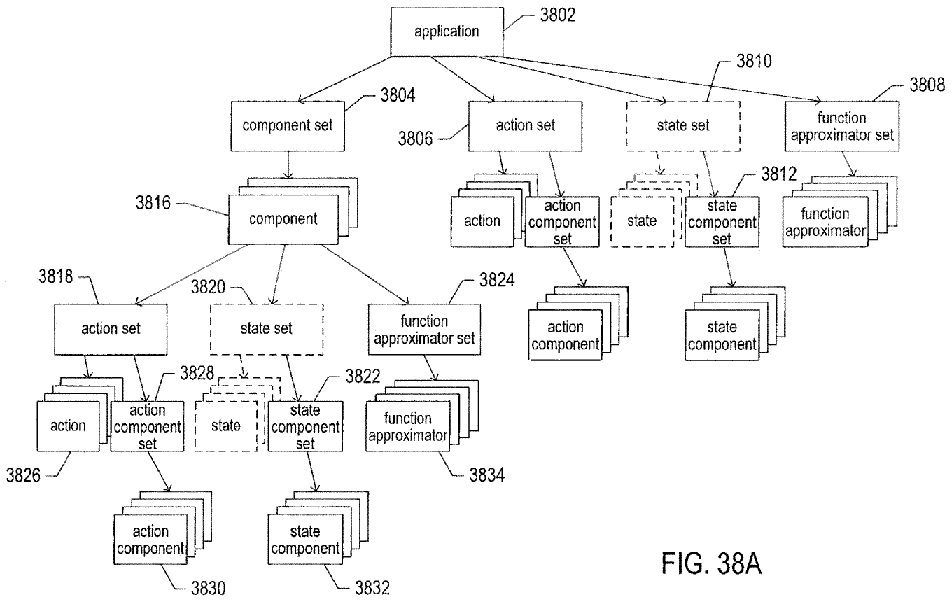

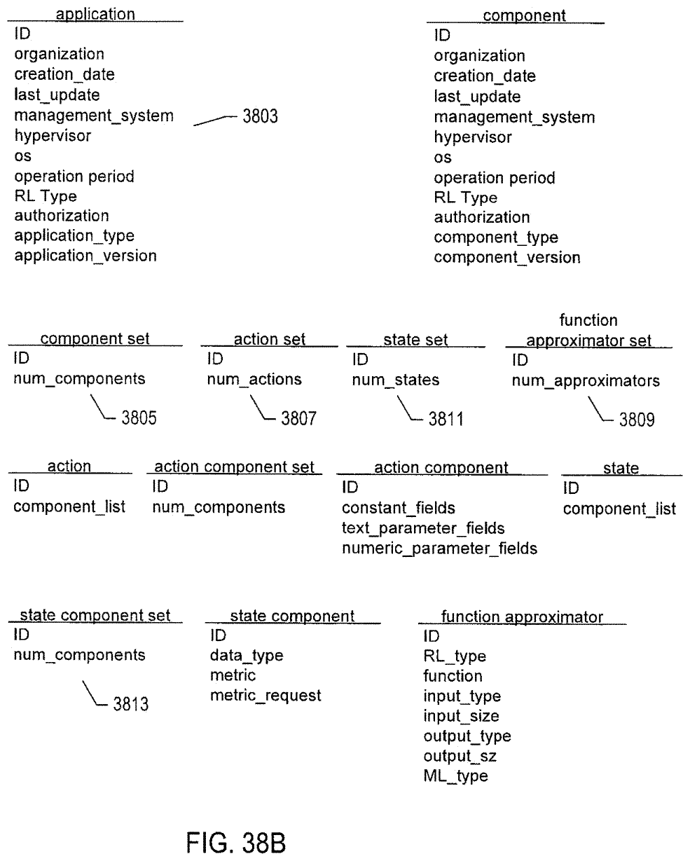

FIGS. 38A-B illustrate one implementation of an application database that is used to store information about pre-trained component-specific function approximators and composite function approximators that can be used to initialize new composite function approximators for RL agents intended to control and manage new distributed applications. The application database is illustrated and discussed at a relatively high level of generality. The application database can be implemented using a variety of different types of data-storage approaches, including relational database management systems, object-oriented-database management systems, formatted files, and other types of data-storage approaches.

FIG. 38A shows the hierarchical structure of the application database. Each existing application is represented by an application node 3802. The application node contains various types of information that describe the application. Examples are shown in the list 3803 of different types of information stored in an application node shown at the top of FIG. 38B. The application node references a component-set node 3804, an action-set node 3806, a function-approximator-set node 3808, and either a state-set node 3810 or a state-component-set node 3812. Examples of the type of information stored in these second-level nodes are shown in lists 3805, 3807, 3809, 3811, and 3813 in FIG. 38B. The component-set node 3804 represents a set of components included in the distributed application. The action-set node 3806 represents the action set for the distributed application. The state-set node 3810 represents the state set for the distributed application. When there are too many states to represent, the application node 3802 directly references a state-component-set node 3812. The state-component-set node 3812 represents a set of elements, or features, included in the state vectors representing the states of the state set. The function-approximator-set node 3808 represents a set of function approximators used in the RL agent that controls the application 3802. In the simple example of an RL agent discussed with reference to FIGS. 34 A-G, the set contains only a single function approximator. As discussed above, alternative reinforcement-learning approaches may use multiple different function approximators. Each distributed-application component is represented by a component node, such as component node 3816. Each component node, like the application node 3802, references an action-set node 3818, a state-set node 3820 or a state-component-set node 3822, and a function-approximator-set node 3824 The action-set node, state-set node, and function-approximator-set node referenced by a component node represent component-specific actions, states, and function approximators, as discussed with reference to FIG. 35B, while the action-set node, state-set node, and function-approximator-set node referenced by an application node represent actions, states, and function approximators for the application, as a whole, as discussed with reference to FIG. 35A. An action-set node 3818 references a set of action nodes 3826 and an action-component-set node 3828 that, in turn, references a set of action-component nodes 3830. Each action node 3026 describes one or more actions. Each action-component node 3830 describes one of the components that can be combined to produce an action. The state-component-set node 3022 references a set of state-component nodes 3832, each of which describes an element within a state vector, including indications of how the element is generated from one or more metric values. A function-approximator-set node 3024 references the set of one or more function-approximator nodes 3834, each of which describes a function approximator used in the RL agent that manages and controls the component of a distributed application or the distributed-application itself. Examples of the types of information stored in the third-level and lower-level nodes are also provided in FIG. 38B. Different implementations of the application database may contain fewer node levels and nodes, different node levels and nodes, or additional node levels and nodes.

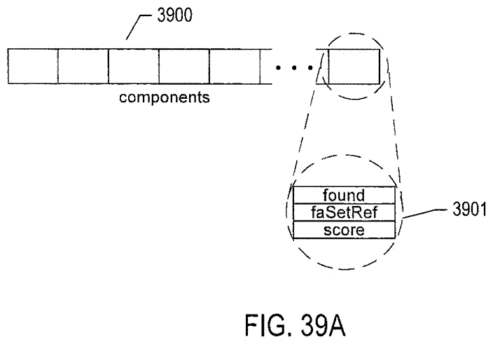

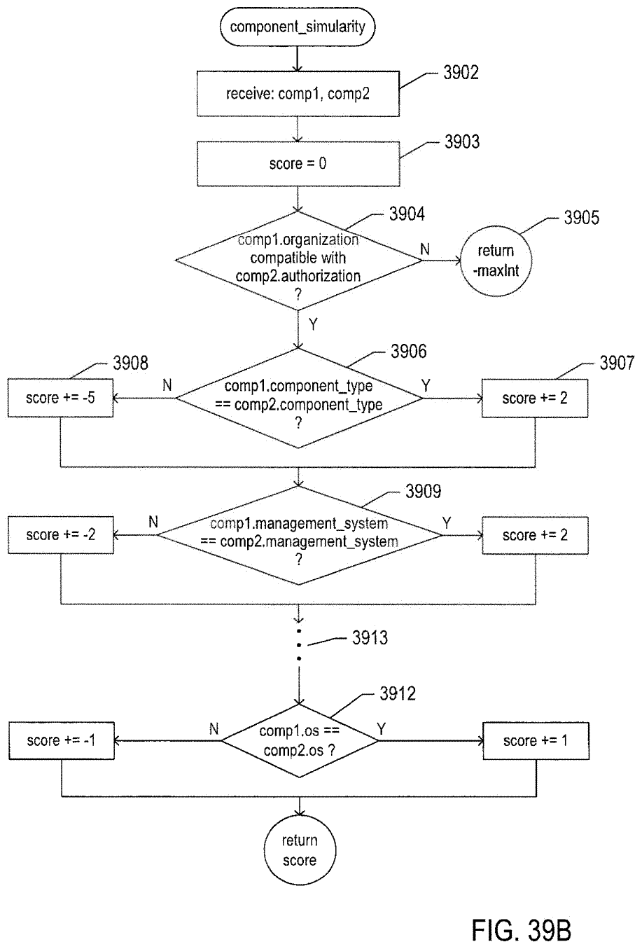

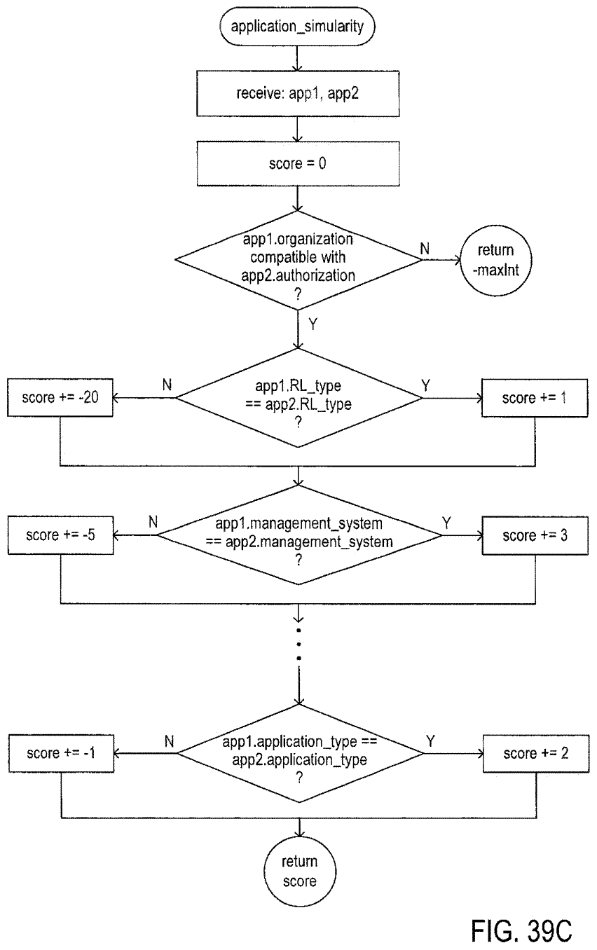

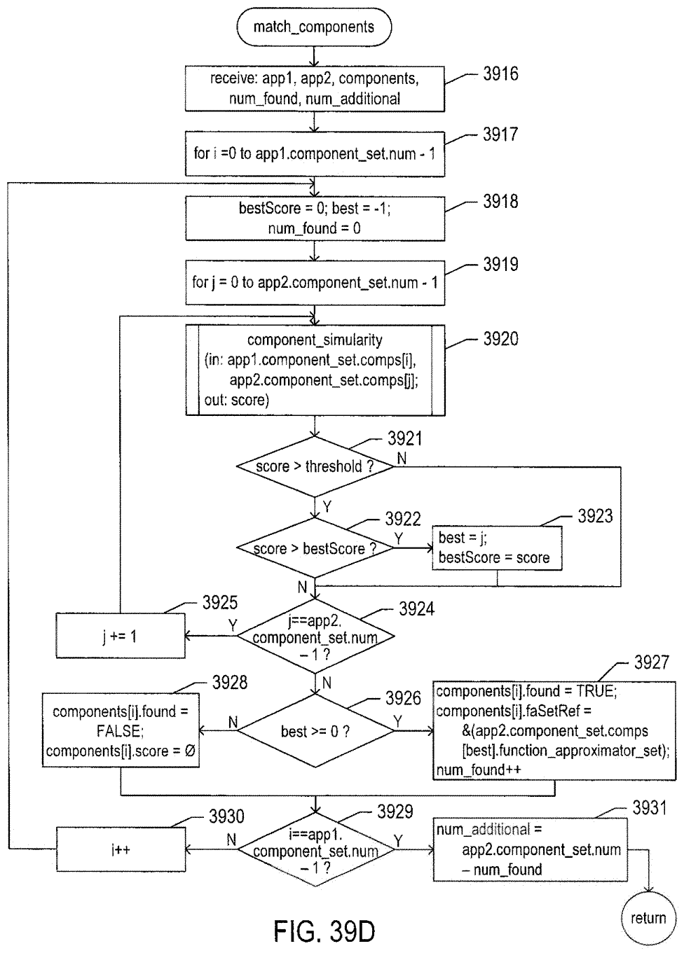

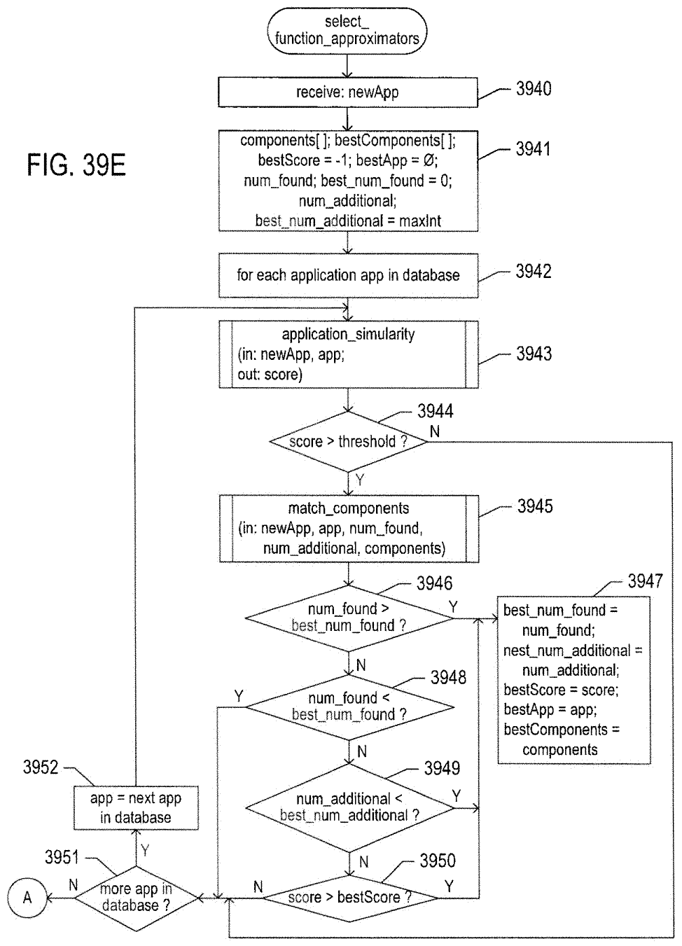

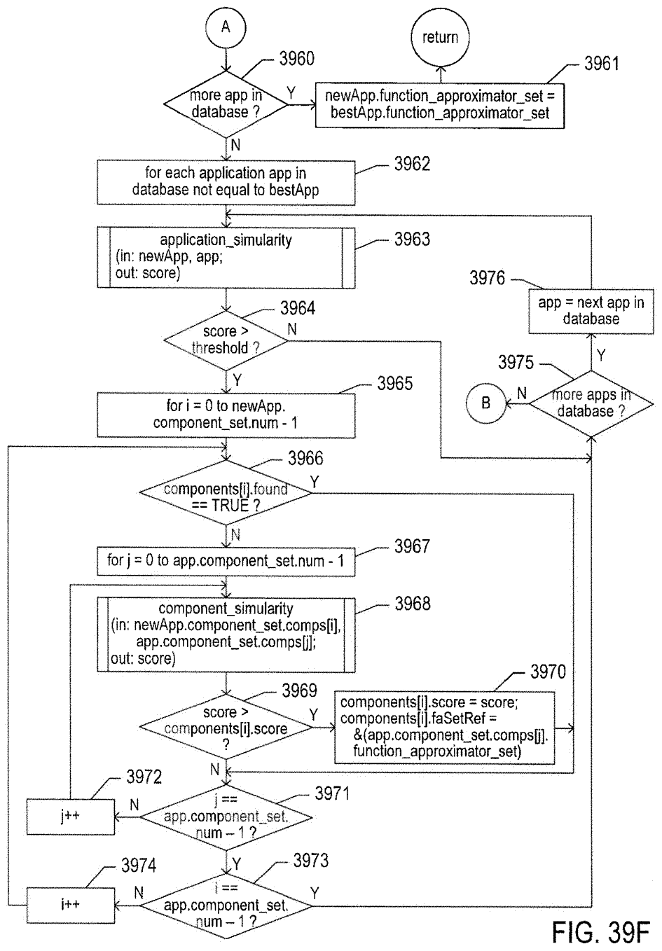

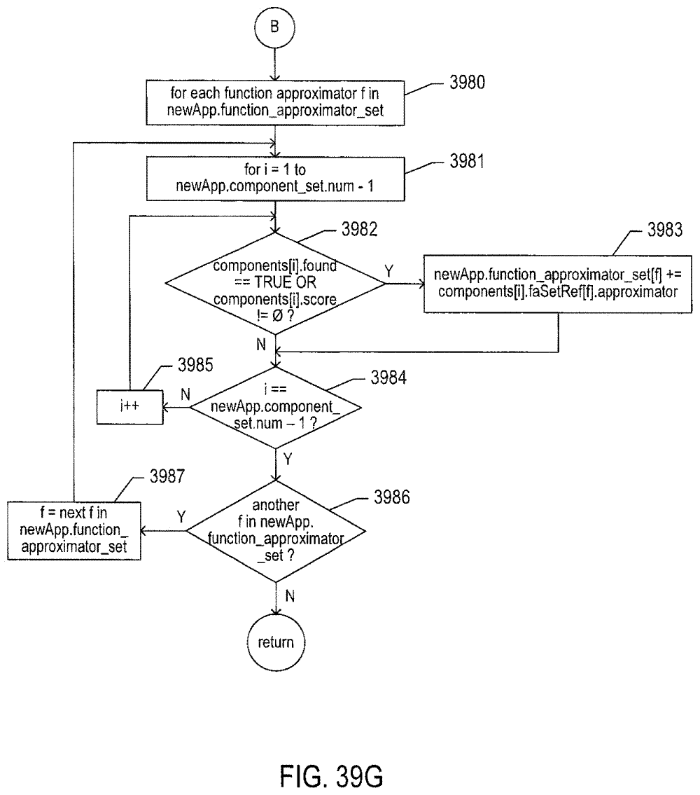

FIGS. 39A-G illustrate implementation of an automated method and system for selecting pre-trained component-specific function approximators for incorporation into a composite function approximator, discussed above with reference to FIGS. 35B and 36, using the application database discussed above with reference to FIGS. 38A-B. FIG. 39 A shows a simple data structure used in the method illustrated in FIGS. 39 B-G. The variable components is a list or an array 3900, each element of which contains a data structure 3901 that includes a field found that stores a Boolean value, a field faSetRef that stores a reference to a function-approximator-set node in the application database, and a field score that contains a similarity score, further discussed below.

FIG. 39B provides a control-flow diagram for a routine “component_similarity” that computes and returns a numeric score indicating the similarity between two components. The components are represented by component-node data structures, discussed above with reference to FIG. 38A. In step 3902, the routine “component_similarity” receives references to two component-node data structures, comp1 and comp2. The component-node data structure referenced comp1 represents a distributed-application component in a new distributed application for which one or more composite function approximators need to be generated. The component-node data structure referenced by comp2 is a component node contained in the application database and represents a component of an existing distributed application. In step 3903, the routine “component_similarity” sets a local variable score to 0. When the organization indicated by data stored in the component-node data structure referenced by comp1 is not compatible with authorization information stored in the component node referenced by comp2, as determined in conditional step 3904, the routine “component_similarity” returns a lowest-possible score in step 3905. The authorization information may contain whitelists, blacklists, credentials, and other information that can be used to determine whether or not the owner or manager of the existing distributed application containing the component authorizes use of a pre-trained component-specific function approximator extracted from the RL-based manager that controls the existing distributed application by the organization owning or managing the new distributed application. When the organization owning or managing the new distributed application is authorized to incorporate a pre-trained component-specific function approximator corresponding to the distributed-application component represented by the component node referenced by comp 2, the routine “component_similarity” begins to compute a similarity score via a number of conditional steps, including conditional steps 3906, 3909, and 3912. These are example comparison steps used to compute a similarity score. Ellipsis 3913 indicates that many additional comparison steps may be employed for computation of the similarity score. The similarity score, for example, may be determined from only information stored in the component nodes, but, depending on the implementation, may be determined from information stored in the component nodes as well as information contained in one or more of the various nodes referenced directly or indirectly from the component nodes. In conditional step 3906, the component type of the component represented by the component-node data structure referenced by comp1 is compared to the component type of the component represented by the component node referenced by comp2. When the two types are equal, the similarity score is incremented by 2, in step 3907. Otherwise, the similarity score is decremented by 5, in step 3908. Conditional step 3909 compares the management systems of the two components and conditional step 3912 compares the operating system that provides an execution environment for the two components. The greater the similarity between the two components represented by the component-node data structure and component node referenced by comp1 and comp2, the higher the computed score.

FIG. 39C provides a control-flow diagram for a routine “application_similarity” that computes a score representative of the similarity between the distributed applications represented by an application-node data structure and application node, the application-node data structure representing a new distributed application for which one or more composite function approximators need to be constructed and the application node representing an existing distributed application. The logic incorporated in the routine “application_similarity” is equivalent to the logic incorporated into the routine “component_similarity,” discussed above with reference to FIG. 39B.

FIG. 39D provides a control-flow diagram for a routine “match_components.” This routine compares the components associated with a new distributed application to the components of an existing distributed application and generates values stored in a components list or array, discussed above with reference to FIG. 39A. In step 3916, the routine “match_components” receives a reference to an application data structure representing a new distributed application, app1, a reference to an application node representing an existing distributed application, app2, a reference to a components data structure, a reference to a variable num_found, which indicates the number of components in the new distributed application that match similar components in the existing distributed application, and a reference to a variable num_additional, which indicates a number of components in the existing distributed application different from any component in the new distributed application. In the outer, for-loop of steps 3917-3930, each component of the new distributed application is considered, with the loop variable i serving as an index into the set of components associated with the new distributed application. In step 3918, local variable bestScore is set to 0, local variable best is set to −1, and variable num_found set to 0. In the inner for-loop of steps 3919-3925, each component in the existing distributed application is considered, with the loop variable j serving as an index into the set of components associated with the existing distributed application. In step 3920, the routine “component_similarity” is called to return a similarity score for the component of the new distributed application indexed by loop variable i and the component of the existing distributed application indexed by loop variable j. When the score returned by the routine “component_similarity” is greater than a threshold value, as determined in step 3921, and when the score is greater than the value stored in the local variable bestScore, as determined in step 3922, local variable best is set to j and local variable bestScore is set to the score returned by the routine “component_similarity,” in step 3923. Thus, the inner for-loop of steps 3919-3925 looks for the component of the existing distributed application that best matches the component of the new distributed application currently considered in the for-loop of steps 3917-3930. When the value stored in local variable best is greater than or equal to 0, as determined in step 3926, then, in step 3927, the element of the list or array components is updated to indicate a component math and the variable num_found is incremented to reflect the match. Otherwise, in step 3928, the element of the list or array components is updated to indicate that no matching component was found for the component of the new distributed application corresponding to the element. Upon completion of the for-loop of steps 3917-3930, the variable num_additional is set to the number of components in the existing distributed application minus the contents of the variable num_found.

FIGS. 39E-G provide a control-flow diagram for a routine “construct function approximators” that selects the best pre-trained component-specific function approximators or monolithic function approximators for a RL-based manger intended to control and manage a new distributed application. In step 3940, the routine “select function approximators” receives a reference to an application data structure representing a new distributed application, newApp. In step 3941, a number of local variables are initialized: (1) an array or list components is initialized to default values; (2) an array or list bestComponents is initialized to default values; (3) local variable bestScore is initialized to −1; (4) local variable bestApp is initialized to a default value; (5) local variable num_found is declared: (6) local variable best_num_found is initialized to 0; (7) local variable num_additional is declared; and (8) local variable best_num_additional is set to some large number. In the for-loop of steps 3942-3952, each application app in the application database is considered. In step 3943, the routine “application_similarity” is called to compare the new distributed application represented by the application data structure referenced by newApp to the currently considered application represented by the application node app. When the score returned by the routine “application_similarity” is greater than a threshold value, as determined in step 3944, the routine “match_components” is called, in step 3945, to attempt to match components of the new distributed application with components in the currently considered distributed application. When the value in local variable num_found is greater than the value stored in local variable best_num_found, as determined in step 3946, the local variables best_num_found, best_num_additional, bestScore, bestApp, and bestComponents are updated, in step 3947, to indicate that the currently considered application is the best matching application with respect to the new distributed application. Otherwise, when the value in local variable num_found is less than the value stored in local variable best_num_found, as determined in step 3948, control flows to step 3951, where another iteration of the for-loop of steps 3942-3952 is considered. When the value stored in local variable num_additional is less than the value stored in local variable best_num_additional, as determined in step 3949, control flows to step 3947 to update the local variables, as discussed above. Similarly, when the score returned by the function “match_components” is greater than the value stored in the local variable bestScore, as determined in step 3950, control flows to step 3947. The for-loop of steps 3942-3952 thus attempts to find the best matching application in the application database with respect to the new distributed application, represented by the application data structure referenced by newApp. When the for-loop of steps 3942-3952 completes, control flows to step 3960 at the top of FIG. 34F.

When the value stored in local variable best_num_found is equal to the number of components in the new distributed application, as determined in step 3960, the function-approximators-set node referenced by the application node referenced by newApp is set to a copy of the function-approximator-set node for the best matching existing distributed application found in the application database, in step 3961, followed by return of the routine “select function approximators.” This represents the case when the monolithic function approximators in the best matching distributed application can be imported directly into the RL-based manager for the new distributed application due to the similarity of the new distributed application to the best matching existing distributed application found in the application database. Otherwise, in the outer for-loop of steps 3962-3976, each application app in the application database not equal to the best matching application, if any, found in the for-loop of steps 3942-3952 is again considered. The routine “application_similarity” is again called, in step 3963, to ensure that the next considered application app has a threshold similarity to the new distributed application, in step 3964. When the currently considered application app is sufficiently similar to the new distributed application, then, in the inner for-loop of steps 3965-3974, each component in the new distributed application is considered, with the loop variable i serving as an index into the component set associated with the new application. When a matching component was not found in the best-matching application, as determined in step 3966, each component in the existing distributed application app is considered in the innermost for-loop of steps 3967-3972. The routine “component_similarity” is called, in step 3968, to compare the currently considered component of the new distributed application to the currently considered component of the existing distributed application app. When the score returned by the routine “component_similarity” is greater than the score stored in the element of the list or array components corresponding to the currently considered component of the new distributed application, as determined in step 3969, that element is updated, in step 3970, to refer to the currently considered component of the existing distributed application app. Thus, the outer for-loop of steps 3962-3976 attempts to find matching components for all the components of the new distributed application that did not match components in the best matching application found in the for-loop of steps 3942-3952. Control then flows to step 3980 in FIG. 39G.

In the outer for-loop of steps 3980-3987, each function-approximator node, indexed by loop variable f, referenced by the function-approximator-set node referenced by the application data structure corresponding to the new distributed application is considered. In the inner for-loop of steps 3981-3985, each component in the new distributed application is considered, with loop variable i used to index each component. When a matching component was found for the currently considered component, as determined in step 3982, a reference to a pre-trained component-specific function approximator for the matching component and for the currently considered function approximator are used to add the pre-trained component-specific function approximator to the function approximator represented by the currently considered function-approximator node. Following completion of the nested for-loops of steps 3980-3987, the routine “select_function_approximators” returns. Thus, the routine “select_function_approximators” receives a reference to an application data structure for a new distributed application and initializes the function approximators referenced by a function-approximator-set node referenced by the application data structure by either importing monolithic function approximators from a best matching application found in the application database or by importing component-specific function approximators for best matching components found in the application database.

The present invention has been described in terms of particular embodiments, it is not intended that the invention be limited to these embodiments. Modification within the spirit of the invention will be apparent to those skilled in the art. For example, any of a variety of different implementations of the currently disclosed methods can be obtained by varying any of many different design and implementation parameters, including modular organization, programming language, underlying operating system, control structures, data structures, and other such design and implementation parameters. While the components of distributed applications, in the current discussion, are sets of instances of distributed-application components, such as front-end, middle-layer, and back-end distributed-application components, there are many additional types of components with respect to which function approximators can be decomposed. The currently disclosed methods and systems can be applied to a large number of different types of reinforcement-learning-based managers and controllers.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An improved reinforcement-learning-based application manager that manages a distributed applications within a distributed computer system, the distributed application comprising two or more distributed-application components, the improved reinforcement-learning-based application manager comprising:
one or more composite neural-network function approximators for reinforcement-learning functions, each composite neural-network function approximator composed of component-specific neural-network function approximators for each of the two or more distributed-application components; and
computer instructions stored in one or memories within the distributed computer system that when executed by one or more processors within the distributed computer system, implement the improved reinforcement-learning-based application manager, the improved reinforcement-learning-based application manager continuously
issuing an action selected by the reinforcement-learning-based application manager to the distributed computer system,
deriving a current state and reward from metric values returned by the distributed computer system, and
updating one or more of the composite neural-network function approximators.

2. The improved reinforcement-learning-based application manager of claim 1 wherein each of the one or more composite neural-network function approximators comprises a neural network that receives a reinforcement-learning-function input and that outputs a function value.

3. The improved reinforcement-learning-based application manager of claim 2 wherein the reinforcement-learning functions include one or more of:
an action-value function that receives an action and a state, as arguments, and returns an estimated discounted total reward value for issuing the action while the environment is in the state;
a belief-distribution function that receives metrics, as arguments, and returns an estimated state;
a state-value function that receives a state, as an argument, and returns an estimated discounted total reward value for the state;
a state-transition function that receives an action, an initial state, and a next state as arguments, and returns an estimated probability that when the action is issued in the initial state, the next state will result; and
a reward function that receives an action, an initial state, and a next state as arguments, and returns an estimated reward.

4. The improved reinforcement-learning-based application manager of claim 2 wherein each of the one or more composite neural-network function approximators comprises:
multiple component-specific neural networks, each component-specific neural network corresponding to one of the distributed-application components;
an input-decomposition component that
receives a function input,
decomposes the function input into a component-specific function input for each distributed-application component, and
outputs each component-specific function input for a distributed-application component to the component-specific neural network corresponding to the distributed-application component; and
a combiner that receives outputs from the component-specific neural networks and outputs a function value.

5. The improved reinforcement-learning-based application manager of claim 4 wherein the combiner is a sub-network.

6. The improved reinforcement-learning-based application manager of claim 1
wherein an action is represented by an action vector comprising a set of ordered elements; and
wherein an action represents one or more commands issued by the reinforcement-learning-based application manager.

7. The improved reinforcement-learning-based application manager of claim 6
wherein each command is represented by one or more elements of the action vector;
wherein a command is issued to a controller or control component; and
wherein the controller or control component may include
a data-center manager;
a virtual-data-center manager;
a cloud-computing-facility manager;
an operating system;
a guest operating system; and
a virtualization layer or hypervisor.

8. The improved reinforcement-learning-based application manager of claim 1
wherein a state is represented by an action vector comprising a set of ordered elements; and
wherein the values of the elements are derived from metric values obtained from the distributed computer system.

9. The improved reinforcement-learning-based application manager of claim 1
wherein a reward is represented by a real-number value; and
wherein the real value is derived from metric values obtained from the distributed computer system.

10. The improved reinforcement-learning-based application manager of claim 1 wherein updating a composite neural-network function approximator further comprises backpropagating a computed loss into the composite neural-network function approximator.

11. A method that improves a reinforcement-learning-based application manager that manages a distributed applications within a distributed computer system, the distributed application comprising two or more distributed-application components, the reinforcement-learning-based application manager comprising one or more neural-network function approximators for reinforcement-learning functions and computer instructions stored in one or memories within the distributed computer system that when executed by one or more processors within the distributed computer system, implement the reinforcement-learning-based application manager, the method comprising:
decomposing an action space for the reinforcement-learning-based application manager into component-specific action spaces;
decomposing a state space for the reinforcement-learning-based application manager into component-specific state spaces; and
replacing the one or more neural-network function approximators with composite neural-network function approximators that each comprises multiple component-specific neural-network function approximators to produce an improved reinforcement-learning-based application manager.

12. The method of claim 11 wherein the improved reinforcement-learning-based application manager continuously
issues an action selected by the reinforcement-learning-based application manager to the distributed computer system,
derives a current state and reward from metric values returned by the distributed computer system, and
updates one or more of the composite neural-network function approximators.

13. The method of claim 12 wherein each of the one or more composite neural-network function approximators comprises a neural network that receives a reinforcement-learning-function input and that outputs a function value.

14. The method of claim 13 wherein the reinforcement-learning functions include one or more of:
an action-value function that receives an action and a state, as arguments, and returns an estimated discounted total reward value for issuing the action while the environment is in the state;
a belief-distribution function that receives metrics, as arguments, and returns an estimated state;
a state-value function that receives a state, as an argument, and returns an estimated discounted total reward value for the state;
a state-transition function that receives an action, an initial state, and a next state as arguments, and returns an estimated probability that when the action is issued in the initial state, the next state will result; and
a reward function that receives an action, an initial state, and a next state as arguments, and returns an estimated reward.

15. The method of claim 13 wherein each of the one or more composite neural-network function approximators comprises:
multiple component-specific neural networks, each component-specific neural network corresponding to one of the distributed-application components;
an input-decomposition component that
receives a function input,
decomposes the function input into a component-specific function input for each distributed-application component, and
outputs each component-specific function input for a distributed-application component to the component-specific neural network corresponding to the distributed-application component; and
a combiner that receives outputs from the component-specific neural networks and outputs a function value.

16. The method of claim 15 wherein the combiner is a sub-network.

17. The method of claim 13
wherein an action is represented by an action vector comprising a set of ordered elements; and
wherein an action represents one or more commands issued by the reinforcement-learning-based application manager;
wherein each command is represented by one or more elements of the action vector;
wherein a command is issued to a controller or control component;
wherein the controller or control component may include
a data-center manager;
a virtual-data-center manager;
a cloud-computing-facility manager;
an operating system;
a guest operating system; and
a virtualization layer or hypervisor;
wherein a state is represented by an action vector comprising a set of ordered elements;
wherein the values of the elements are derived from metric values obtained from the distributed computer system;
wherein a reward is represented by a real-number value; and
wherein the real value is derived from metric values obtained from the distributed computer system.

18. A method that generates neural-network function approximators for a reinforcement-learning-based application manager that will control and manage a new distributed application from pre-trained neural-network function approximators, the method comprising:
receiving configuration information for the new distributed application;
accessing an application database that stores information about existing distributed applications controlled by reinforcement-learning-based application managers; and
for each neural-network function approximator to be incorporated into a reinforcement-learning-based application manager that will manage and control the new distributed application,
when an existing distributed application is described by information in the application database for which a similarity comparison generated for the new distributed application and the existing distributed application is greater than a threshold value and which includes a set of components identical to the set of components of the new distributed application,
incorporating a pre-trained neural-network function approximator from the reinforcement-learning-based application manager that manages and controls the existing distributed application into the reinforcement-learning-based application manager that will control and manage the new distributed application, and
when no existing distributed application is described by information in the application database for which a similarity comparison generated for the new distributed application and the existing distributed application is greater than a threshold value and which includes a set of components identical to the set of components of the new distributed application,
for each component in the new distributed application,
when a component with greater than a threshold similarity is described by information in the application database, incorporating a pre-trained component-specific neural-network approximator for the component into a composite neural-network approximator for the neural-network function approximator for the reinforcement-learning-based application manager that will control and manage the new distributed application.

19. The method of claim 18 wherein the similarity comparison for the new distributed application and the existing distributed application is generated from multiple comparisons of attributes and characteristics of the distributed applications, including one or more of:
the organization that owns and/or manages the new distributed application and authorization criteria associated with the existing distributed application;
the type of management systems and/or controllers to which the reinforcement-learning-based application managers that control and manage the distributed applications interface;
the type of hypervisor and/or virtualization layer that provide support for the distributed applications;
the type of operating system that provides support for the distributed applications;
the type of reinforcement learning employed by the reinforcement-learning-based application managers that control and manage the distributed applications;
the number and types of components within the distributed applications; and
the sizes and contents of the action spaces and state spaces associated with the distributed applications.

20. The method of claim 18 wherein the similarity comparison for a component of the new distributed application and a component of the existing distributed application is generated from multiple comparisons of attributes and characteristics of the distributed-application components, including one or more of:
the organization that owns and/or manages the new-distributed-application component and authorization criteria associated with the existing-distributed-application component;
the type of management systems and/or controllers to which the reinforcement-learning-based application managers that control and manage the distributed applications containing the components interface;
the type of hypervisor and/or virtualization layer that support the distributed-application components;
the type of operating system that supports the distributed-application components;
the type of reinforcement learning employed by the reinforcement-learning-based application managers that control and manage the distributed applications; and
the sizes and contents of the component-specific action spaces and component-specific state spaces associated with the distributed applications.
